(19) United States
(12) Patent Application Publication
(10) Pub. No.: US 2008/0140484 A1
(43) Pub. Date: Jun. 12, 2008

(54) System and method for creating and managing intelligence events for organizations

(76) Inventor: Ofer Akerman, Jordan Valley (IL)

Correspondence Address: Mark Levy;HINMAN, HOWARD & KATTELL, LLP, 80 Exchange Street, P.O. Box 5250, BINGHAMTON, NY, 13901, US

(21) Appl. No.: 11/999,832

(22) Filed: Dec. 6, 2007

Related U.S. Application Data
(60) Provisional application No. 60/873,719, filed on Dec. 8, 2006.

(51) Int. Cl. G06F 17/40

(52) U.S. Cl. 705/7

(57) ABSTRACT

A system and method for creating and managing intelligence events for organizations. An enterprise intelligence management system (EIMS) is provided for consolidating information, experience, and interpretations into intelligence events. An intelligence trading platform (ITP), operatively connected to the EIMS, converts intelligence events into intelligence assets and provides a venue for buying and selling said intelligence assets. The system includes software for a website that provides the main venue for intelligence transactions. The consumer is sold access to the intelligence trading platform and the database. An adaptive report can be generated in response to a request by the consumer. The EIMS includes an intelligence client module, an adaptive context builder, a template manager, a corporate intelligence distribution module, an intelligence ranking layer, and a finance manager.

### RELATED APPLICATIONS

This application is a Continuation-in-Part of Provisional U.S. Patent Application Ser. No. 60/873,719, filed Dec. 8, 2006 and claims priority thereto in accordance with 35 U.S.C. §1.78.

### FIELD OF THE INVENTION

The present invention pertains to organizational intelligence, and, more particularly, to a system and method for creating and managing intelligence events for organizations.

### BACKGROUND OF THE INVENTION

For the purposes of this disclosure, “intelligence” and “intelligence events” refer to business intelligence. The system and method, however, can be applied to any form of intelligence useful to corporate, political, or military entities or to private individuals. Such organizations include but are not limited to: manufacturers, public and private service providers, social clubs, charities, philanthropic and other non-profit organizations, religious organizations, unions, sports teams, incorporated individuals, school districts, colleges and universities, research companies, consulting services, local governments, the arts and entertainment industry, hospitals and other components of the health care industry, and banks and brokerage firms.

Intelligence data required for corporate decision-makers is deeply fragmented because it comes from many sources. The day-to-day activity of any business generates a great deal of information; much of it is factual, and employees and managers invariably interpret the facts in light of their own professional and sometimes personal experiences. But their views are necessarily limited: no one person can see every aspect of a situation or event.

Business intelligence (BI) providers, like Business Objects and Hyperion, offer multi-dimensional databases and queries that can combine a variety of parameters from different business processes into a consolidated report. Today's heterogeneous business environments are increasingly dependent on the efficient and timely distribution of contextualized information; the use of BI for internal improvement alone is not enough to win in Asymmetric Business Warfare. The challenge is to collect and distribute intelligence effectively and to preserve a sensitive balance between quantity and quality. Traditional businesses, moreover, use generally inconsistent mechanisms for rewarding their employees, from the amorphous promise of a raise or promotion to the merchandise incentives offered in multi-level marketing processes.

Google, ask.com, and other leading search engines use sophisticated algorithms to index data and build analytic contexts. They are information driven; their approach organizes massive amounts of information into classifications that will fit into many search criteria. Everyone accessing these sites for specialized information sees the same results, whether he/she is the CEO or a field level employee, regardless of his/her residence, education, experience, or culture. There is no mechanism for judging the quality of the information and there is no source accountability for outdated information or false information: outright errors, poor interpretation, misleading data, etc. Intelligence consumers are left on their own to determine the quality and relevance of what they learn online.

Modern multinational organizations are complex structures in which information is gathered from multiple sources in locations frequently remote from organization headquarters. Employees work all around the world but cannot communicate easily with each other because of language barriers, and distance in time and space. The people in the organization who are exposed to information may be in the field and may not understand the overall business processes of the company, nor do they make the decisions that affect the company. They have information but do not have the chance to use it effectively.

The C-level executives at headquarters making the strategic decisions for the organization are not necessarily exposed to the information possessed by local employees. They understand the workings of the market and of their business, but they make decisions without all of the data. A way is needed to distribute local intelligence from field employees throughout the company so it is available to those who need it to make the organization more productive, more efficient, and more profitable.

### SUMMARY OF THE INVENTION

In accordance with the present invention, the inventive system is an event-driven on-demand intelligence platform that uses cutting edge web 2.0 technologies and government level security standards. The inventive system's fundamental data unit is the event and its fundamental structural unit is the hierarchy. Its purpose is to provide a mechanism whereby users can at will enter random pieces of structured and/or unstructured data, define the logical links among them, and apply their own personal interpretations (based on but not limited to cultural, historical, intellectual, and/or emotional responses) and assessments, thus creating a self-enclosed data unit called an “intelligence event.” A particular user's “event” becomes in itself a link in a chain of intelligence events that are organized vertically and horizontally within the system. Intelligence events are analyzed, evaluated, reorganized, cross-referenced, and refined at each stop along the hierarchy, so that only the highest quality, most pertinent, and most valuable information rises to the top of the organization.

The inventive system also monitors the handling of information within an organization and provides an immediately accessible visual illustration of human and mechanical intelligence routes, simplifying the assessment of their effectiveness. Each link and/or series of links in the information chain is shown graphically on the computer screen, so that users at every level can visually track the evolution of an intelligence event and/or identify blocks in the information flow as well as points of peak efficiency.

Thus, an intelligence event is the encapsulation of logical links among data elements and human interpretation of data, which includes personal estimations of the immediate and long-term risks/threats/opportunities that the data presents to an organization and the appropriate or necessary tasks associated with the information. In this way, the inventive system effectively manages the loop of intelligence gathering/intelligence processing/intelligence execution.

The inventive platform allows power searches based on an integrated matrix that weaves together intelligence ranking, analytic context, and human interpretation. The inventive platform's focus on human intelligence is supported by a professional framework of incentives to reward employees for their contributions and collaborations. The reward mechanism, called Corporate Intelligence Mileage (CIM), is flexible and can be customized by any organization and/or for any cultural context. This allows an organization to value and leverage every form of diversity.

Reporting data is as easy as sending text messages. The inventive platform can process any form of data. E-mails, voicemail messages, memos, web sites, personal experiences, overheard conversations, news reports, and other sources of unstructured or structured data, merge seamlessly into structured intelligence events. The inventive platform's user-friendly program automatically converts a variety of formats (Word documents, PDF files, Power Point presentations, Excel spread sheets, input from hand held devices or cell phones, etc.) into editable content that can be easily viewed on a computer screen and manipulated by the user to shape his/her understanding and interpretation.

The inventive platform comprises two distinct parts, each with its own function: an Enterprise Intelligence Management System (EIMS), a mechanism for collecting, analyzing, and evaluating data and for integrating data with interpretation to create intelligence events, and for creating intelligence assets therefrom; and an Intelligence Trading Platform (ITP), operatively connected to the EIMS, a mechanism for trading said intelligence assets. The EIMS is a software package that supports intelligence-gathering and distribution within an organization; it stands alone and may be purchased separately. The ITP is additional software that transforms intelligence into a commodity that can be bought and sold across corporate, political, or military boundaries. The inventive platform employs hierarchical structures to classify and rank data within an operational context, and to allow hierarchical access to the resulting intelligence. In addition to the hierarchical intelligence flow, the inventive platform also supports horizontal intelligence handling to define potential actions, threats, or opportunities that are of direct, immediate need and/or interest to the user.

### BRIEF DESCRIPTION OF THE DRAWINGS

The present invention may be understood by referring to the following illustrations in conjunction with the detailed description that follows; the drawings illustrate the uses of the inventive platform in a business context, but must be understood to include political, military, or personal applications as well:

FIG. 1 is a graphic illustration of a business intelligence solution of the prior art;

FIG. 2 is a graphic illustration of a contemporary multinational corporation;

FIG. 3 is a graphic illustration of the inventive system's multi-layer platform architecture;

FIG. 4 is a graphic illustration of the inventive concept as integrated with the business intelligence solution shown in FIG. 1;

FIG. 4A is a pyramid diagram of the movement from intelligence event to saleable intelligence;

FIGS. 5 and 6 illustrate the importance of context to BI management;

FIG. 7 is a graphic illustration of the intelligence trading platform used with the inventive system in accordance with the present invention;

FIG. 8 is a block diagram of the components of the enterprise intelligence management system (EIMS) in accordance with the invention;

FIG. 9 is an illustration of the inventive system's computer screen as seen by a user in accordance with the present invention;

FIGS. 10-17 are other examples of computer screens in accordance with the present invention;

FIGURE A is an example of how a user can employ web plug-ins to convert sources into editable content;

FIG. 18 is an example of how a computer screen may be customized by a user in accordance with the present invention;

FIGS. 19-21 are examples of computer screens used by a company executive in accordance with the present invention;

FIGURE B illustrates the visual intelligence route map;

FIG. 22 is a diagram of the inventive system's two complementary subsystems;

FIG. 23 is a schematic view of the inventive concept architecture;

FIG. 24 is a diagram of the user management and profiling algorithm;

FIG. 25 is another diagram of the user management and profiling algorithm;

FIG. 26 is a flow chart of system operations and interactions with a consumer;

FIG. 27 is a block diagram of reverse bidding;

FIG. 28 is a block diagram depicting the main components of the EIMS;

FIG. 29 is a block diagram of the intelligence broker module;

FIG. 30 is a block diagram of the adaptive context builder;

FIG. 31 is a block diagram of the adaptive template generator;

FIG. 32 is a block diagram of the adaptive report generator;

FIG. 33 is a flow chart of the corporate intelligence distribution module;

FIG. 34 is a block diagram of a CIH;

FIG. 35 is a block diagram of the CIH's main components;

FIG. 36 is a block diagram of the credibility manager;

FIG. 37 is a block diagram of the adaptive credibility matrix;

FIG. 38 is a block diagram of the CIH Financial Manager;

FIG. 39 is a block diagram of an intelligence trading transaction; and

FIG. 40 is a block diagram of a reverse transaction.

### DETAILED DESCRIPTION OF THE PREFERRED EMBODIMENT

In accordance with the present invention, there is provided a system for gathering information and transforming it into intelligence events, and converting intelligence events into intelligence assets. The inventive platform comprises two distinct parts, each with its own function: an Enterprise Intelligence Management System (EIMS), for collecting, interpreting, and evaluating data and for integrating data with interpretation to create intelligence events, and for creating intelligence assets therefrom; and an intelligence trading platform (ITP), operatively connected to the EIMS for trading said intelligence assets. The EIMS is a software package that supports intelligence-gathering and distribution within an organization; its fundamental data unit is the event. EIMS stands alone and may be purchased separately. The ITP is additional software that transforms intelligence into a commodity that can be bought and sold across corporate boundaries.

Organizations need local intelligence to grow globally. The inventive platform gathers and synthesizes local information and delivers important intelligence to decision makers. By taking advantage of company-wide social networking to gain practical, relevant information in real time, the system introduces military intelligence-gathering techniques into an organizational intelligence management context. By doing so, the system increases accountability and minimizes politics within the ranks of an organizations; the system also mitigates cultural biases in information flow, cultivates a knowledge-centric working environment with a structured system of rewards, pinpoints corporate intelligence bottlenecks, and provides the ultimate incentive for intellectual collaboration. The system is subscription based and requires no user installation.

The inventive platform meets an organization's contemporary intelligence gathering challenges by providing easy access to intelligence reporting templates which are merged hierarchically into a corporate central intelligence portal. Additionally, by offering experts in any field a venue where they can sell what they know to consumers/organizations which need specialized information and are willing to pay a fair price for it, the inventive platform transforms intelligence gathering itself into a potentially profitable business in its own right.

The inventive platform improves an organization's intelligence gathering process while simultaneously enhancing its existing practices. The inventive platform focuses on human intellect and experience using local interpretations and responses from every level of the organization to create the central intelligence database. Anyone with a relationship to the organization may provide valuable information: employees, volunteers, partners, customers, consultants, and PR people. The inventive platform allows organizations to maximize their investment in their workers: with one more dollar per employee for equipment and training, upper management provides him/her with the ability to communicate valuable information to the company.

There are two ways to gather intelligence: bottom-up and top-down. The bottom-up method allows field level employees to pass their intelligence to the next level in the hierarchy, where their managers take the information and wrap their own analysis around it before sending it up to the next level. If two employees report separate intelligence events that are related to each other, the manager can combine these reports into one. The inventive platform's mechanism for the compilation of reports decreases the volume of data that moves up the hierarchy to company executives and refines the quality of the information, so there is no overload of intelligence to be sifted through.

In the top-down method, a decision maker who needs information on a specific topic issues a Strategic Intelligence Inquiry (SII) through the system, asking employees to concentrate on that particular issue, so that employees in every office know what intelligence topic is of immediate importance to the organization.

The inventive platform allows managers to set up pre-defined information routes. Field-level employees can also determine whom to relay intelligence to, thanks to a two-way handshake authorization process. If an employee wants to report information to someone who has not been predefined, he/she can send a request to that person. When the request is approved, the intelligence report is automatically sent. These routes can be tracked visually on the computer screen, which allows managers to see who is effectively processing the information and who is creating bottlenecks in the system.

The inventive system encourages employees to take responsibility for collecting and distributing information. Managers can see who reports what intelligence and can judge its relevance to the organization. Because the inventive platform allows clear visible tracking of who is contributing what kind of data, individuals can be held accountable for what they report and what they fail to report. The inventive platform implements a structured incentive system, called Corporate Intelligence Mileage (CIM), which rewards employees for reporting information.

Security is crucial when dealing with important information and data. The platform security measures contain high level security devices and multiple security layers to protect the corporate intelligence that the system provides.

Customer data is protected by running the inventive system on multiple, geographically dispersed, fully mirrored data centers with extensive back-up, data archive, and fail safe capabilities to provide seamless disaster recovery.

The inventive platform supplies a mechanism whereby employees can transform their intellectual property into quantifiable, saleable assets which can be traded on the open market. Contributors can thus advance in their careers as they gain visibility in their industries, increase their incomes, and earn recognition as experts in their fields.

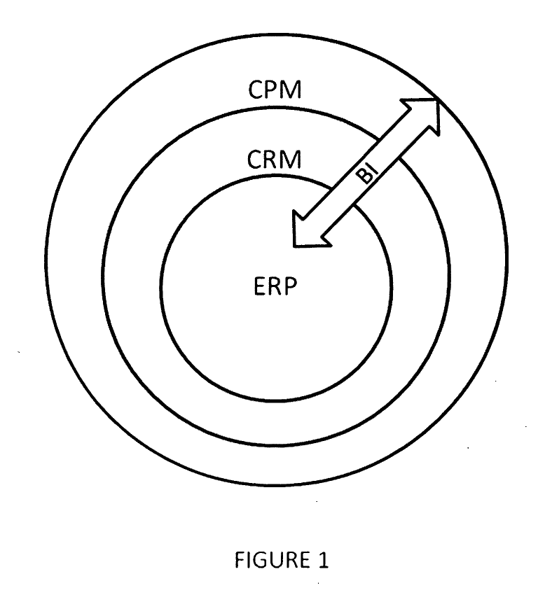

Referring now to FIG. 1, business intelligence solutions are process-centered, meaning that their value is measured by how well they improve existing business processes. Such applications include Enterprise Resource Management (ERP) 102, Customer Relations Management (CRM) 104, and Corporate Performance Management (CPM) 106.

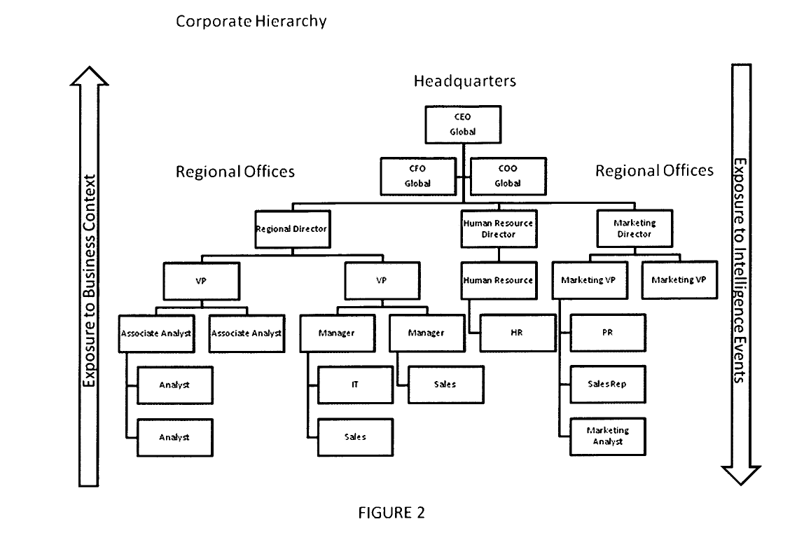

FIG. 2 illustrates the complex structure of a multinational corporation, in which events, information, intellect, and experience are distributed around the globe.

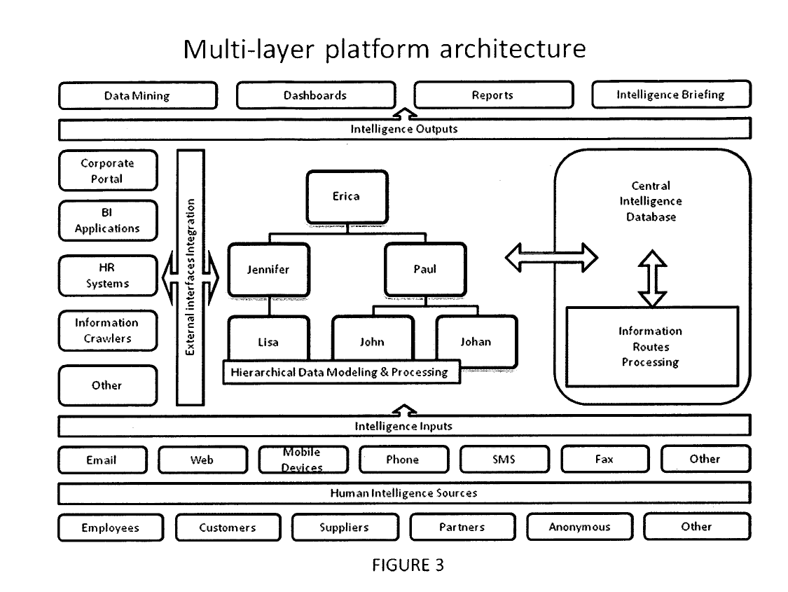

The Inventive System's platform architecture, FIG. 3, is designed to support a wide variety of intelligence reporters 302 and reporting methods 304. Pieces of information are organized along a flexible information route 312. Hierarchical data processing 301 add to diagram encapsulates interpretations, predictions, and recommendations. People at every link along the information chain can add their own interpretations and even merge several pieces of intelligence in any format into a contextual report. The context is built by agents with the most relevant background. The information then moves up the hierarchy where the fragments are rendered and distilled into intelligence events. The inventive platform's central intelligence database 310 holds the encapsulated records as the fundamental data unit and keeps a detailed transactional log that allows any level of drill down and referencing.

FIG. 3 thus illustrates the architecture of the inventive platform, which consists of:
Human intelligence sources: employees/customers/members/partners and others who can report intelligence in any of the given methods 302.
Intelligence input methods, including but not limited to: Word, PDF, Excel, PowerPoint, email, mobile devices, faxes, voice messages, web, SMS etc 304.
Intelligence outputs: the unique outcomes of the system, i.e., intelligence briefing and advance reports with data mining capabilities 306.
External integration interfaces: export/import data to/from other systems 308.
Central intelligence database: includes all the hierarchical and encapsulated records 310.
Hierarchical data modeling/processing 312 is the main module to render information fragments into intelligence events by encapsulating human interpretations with any data item and distilling it through the organization's hierarchical information routes. The context is uniquely built by the links inside the hierarchical information chain and stored as encapsulated records in the database.

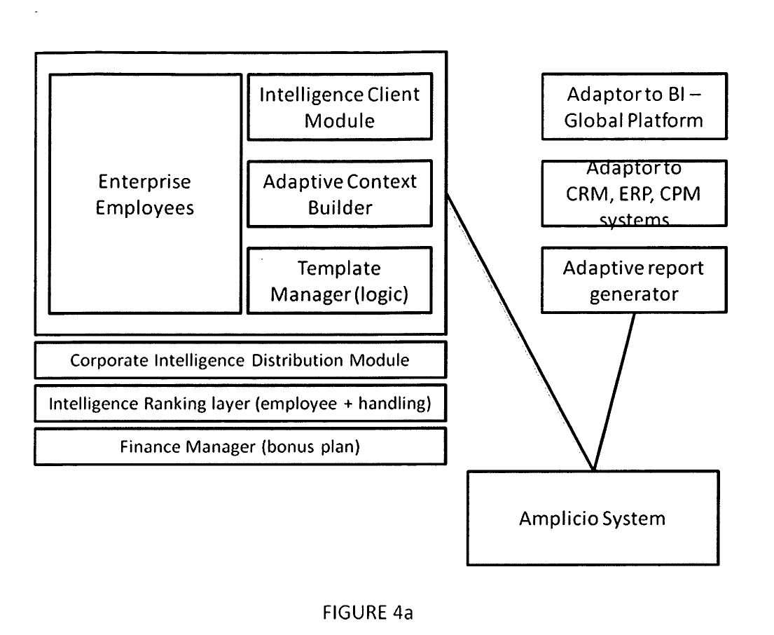

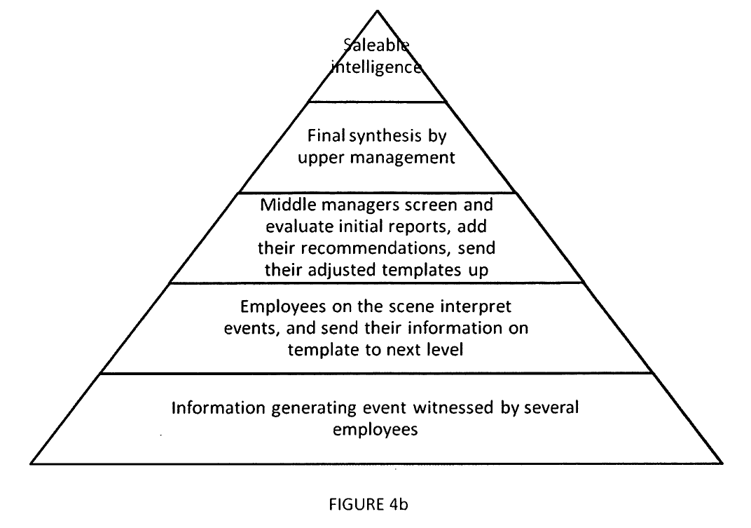

Referring now to FIG. 4, EIMS includes an organization employee module 400 for gathering information, validating templates allowing employee interpretation and recommendations, and supervisor threads for clarification. An intelligence client module 402 allows brokers to gather, interpret, and manage intelligence events. An adaptive template generator 404 defines the intelligence scheme and logic followed by brokers. An adaptive context builder 406 analyzes threads and sources of the brokers. An intelligence distribution module 408 distributes intelligence within an enterprise. An intelligence ranking module 410 evaluates and rates the interpretations of contributors, the intelligence reports, and the efficiency at handling the above. A finance manager module 412 provides brokers with financial incentives and with a virtual trust account ensuring completion of transactions between the consumer and the intelligence broker.

The inventive system is subscription based; and because it is a Web-based system, it requires no client installation. Intelligence information can be reported on any web-based browser, as well as by handheld devices such as a BlackBerry. The system provides built-in security measures and utilizes the best in breach security products to ensure data safety.

The inventive system is based on hierarchical data modeling. In accordance with a dynamic flow of organizational information, the system encapsulates random data and contributor interpretations to create intelligence events. It uses diverse contributor profiles together with the identification of international links to build a human context for analyzing information which is gathered and made into a coherent intelligence product. The inventive system utilizes groups of abstract classification keywords which are defined by managers who supervise the members of the organization and which form a two-way handshake for authorization, insuring that security is maintained. Words like “software,” “engineering,” “projects,” “London,” and so forth, define an employee's responsibilities in the organization and create his/her profile. The inventive system produces a list of members and keywords for approval. A member can define his/her own keywords, but his/her supervisor, department manager, HR manager, or any other executive authorized by the inventive system administrators must approve such personalized keywords. The inventive system offers intelligence reporting templates that encompass advanced computer logic, making the platform intuitive for any level of user, whether he/she is initially gathering and reporting, commenting, questioning, or utilizing such intelligence information as is developed by the organization.

The functionality of the inventive system includes spell check, rich text editing, marking, and converting of any type of source (including but not limited to PDF, Web, Office documents, Excel spreadsheets, etc) into editable text. The users can highlight important content and add their own predictions and recommended actions. The inventive system's hierarchal structure of transferring intelligence through international links solves any language problem. The inventive system supports advanced linguistic information extraction and translation into over 30 languages.

Referring to FIG. 4A, once an intelligence report has been made ready, the inventive platform takes it to the next rung on the information ladder. Managers can now merge many separate intelligence reports into a single intelligence event and through that process build the ultimate contextual report for a given layer. At any time, the managers can clearly see the information flow map and intelligence report evolution on the computer screen.

The inventive platform combines intelligence-gathering methods used by political and military agencies with a unique system of incentives, called Corporate Intelligence Mileage (CIM), to encourage employees at every level of the organization to participate in the reporting and analysis of observed events and data. The implementation of the rewards system supports the development of any organization's internal culture and unites employees from all over the world with corporate headquarters while giving upper managers instant access to field level intelligence with the additional advantage of both context and interpretation. Any employee may send information concerning intelligence-generating happenings directly to his/her office computer immediately as he/she observes them by using a cell phone, Blackberry, or other handheld device; upon returning to the office, he/she may retrieve the data and prepare it for submission.

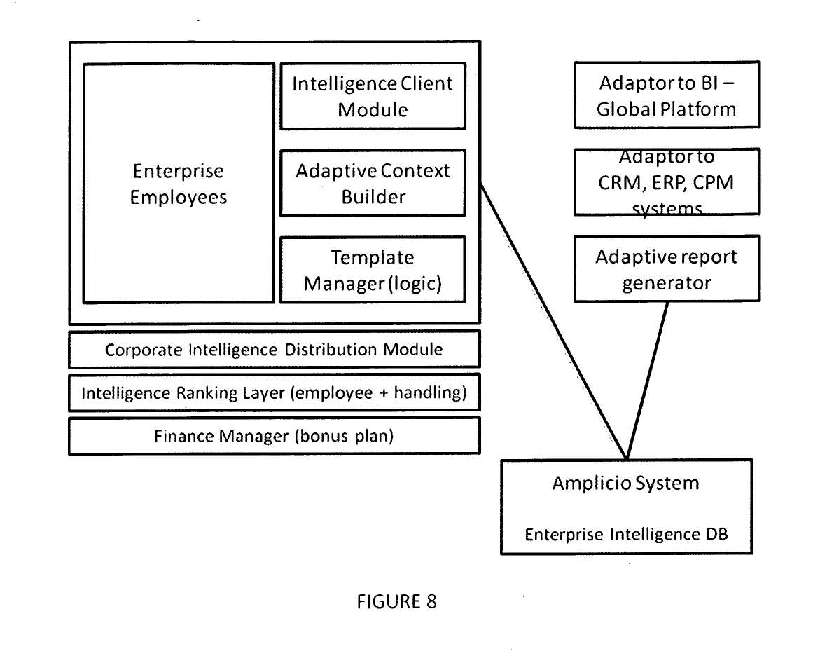

Employees are ranked by how much and how often they submit intelligence, and by the quality of the information they offer. Those who make regular, significant contributions of high quality data with thoughtful interpretation and attention to detail and context, are rewarded with Corporate Intelligence Miles and which are entered into each employee's online account statement; as the miles accumulate, they may be redeemed for prizes such as trips, theater tickets, or cash. Thus, the gathering of information is a friendly competition among employees and increases socialization within the organization. Moreover, the path of the information can be tracked visually on computer screens, shown in FIGS. 8-20, allowing managers to identify who is impeding the upward flow of information and at what level such carelessness or inattention occurs. Thus, implementation of the system keeps an organization operating at peak efficiency.

The EIMS transforms random information into intelligence events and the ITP transforms intelligence events into intelligence assets that can be bought and sold on an open market. In an organizational environment where systems are designed to operate perfectly, independent of individual workers, the inventive platform uses the human element in much the same way that military/political intelligence gathering dependents almost exclusively on personal interactions. The inventive platform establishes an efficient structure that derives its meaning from personal interactions among employees and between individual employees and their environments. It restores context to content. By collecting and synthesizing information from employees living in different cultures and locations, who each interpret the same data differently, the inventive system extracts valuable intelligence from diverse sources. With each employee applying the data his/her own analyses and interpretations of the threats/opportunities/predictions that the data presents, the decision makers view and understand the information from a variety of perspectives.

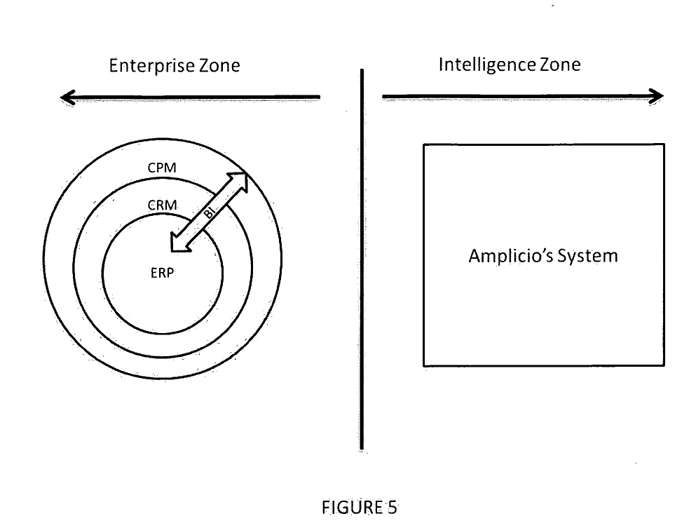

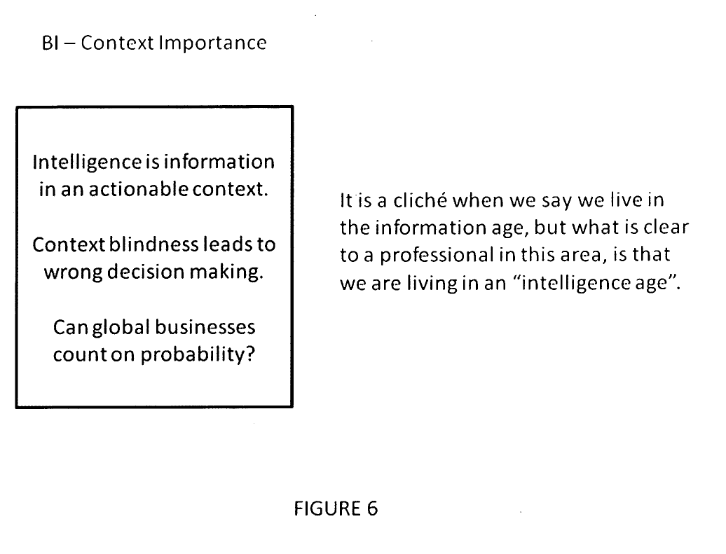

FIGS. 5 and 6 illustrate why the two components, content and context, are essential to each other: an Enterprise Zone 502 operates efficiently within its own parameters, but remains somewhat isolated from an Intelligence Zone 504. Moreover, within an Intelligence Zone 504, much is hidden. In the Intelligence Zone 504, the cat seems ill-advised in crossing the deeper part of the puddle because the viewer cannot see the whole picture. When the viewer is able to see what the cat sees, namely a row of dogs to her left 600, her choice seems thoughtful and well-considered.

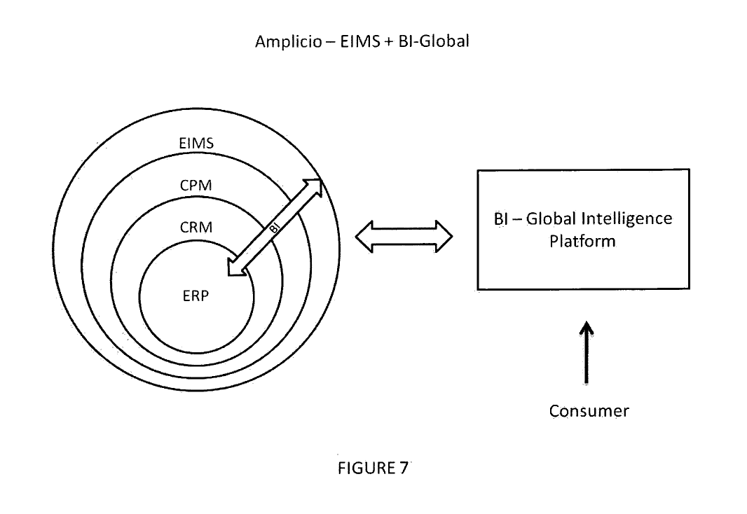

FIG. 7 illustrates the overall structure of the inventive platform: it provides EIMS 702, which consolidates information from a variety of sources into intelligence events; and ITP 704, operatively connected to the EIMS 702, which generates a database of customized intelligence assets 706, first for upper managers and decision makers, and then for the intelligence consumer 708 who is sold access to ITP and the database.

Referring now to FIG. 8, EIMS 702 includes an Intelligence Client Module 802, an Adaptive Context Builder 804, a Template Manager 806, a Corporate Intelligence Distribution Module 808, an Intelligence Ranking layer 8010, and a Finance Manager 8012.

The system includes but is not limited to computer software for an organization's website which provides an online hub where intelligence contributions by employees can be recorded, consolidated, and sent up the information supply chain. With the addition of the Intelligence Trading Platform, the company hub also becomes a venue where intelligence transactions take place. Access to the system is hierarchical: each employee has a degree of access determined by his/her position in the organization. Low-level workers in the field have the least access, CEOs and Boards of Directors have the most.

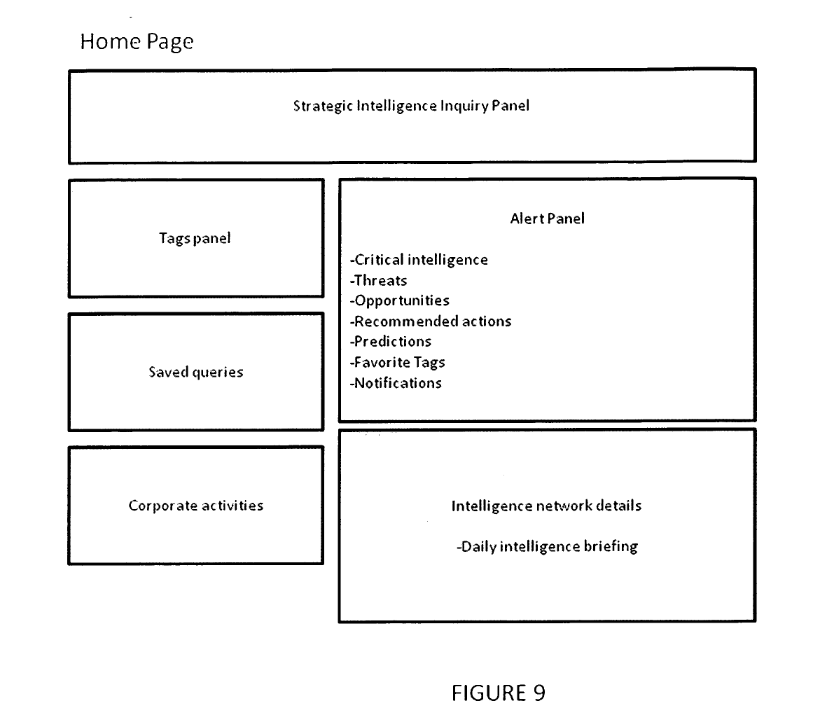

FIGS. 9, 10, and 11 are screen shots of what an employee might see upon logging in to the inventive platform's Intelligence Portal 900, the Intelligence Desktop. The employee can also easily search the site for information relevant to his/her own personal work projects because the pages are designed like familiar web search engines like Google or Yahoo. The main page contains general news pertaining to the industry 902 and in-house news about the company, including current events 904, social events, and information of general interest that any employee might see regardless of his/her position or security clearance. These news items contribute to the social life of the company and help to connect employees to each other over geographic boundaries. This main page may be customized to meet the needs of any organization as an expression of its collective image and culture.

When an employee logs in, he/she can see the news pertaining to the company from any location, foreign or domestic; view basic information about his/her account including his/her status 906 and how many Corporate Intelligence Miles he/she has accumulated 908, and find information about what prizes and rewards are available 9010 and what each costs in CIMs 9012. Most importantly, the employee can instantly see a record of his/her intelligence-related activities 9014, including the total number of intelligence contributions and the number of pending intelligence items (i.e., items sent to the computer from an external location and which are waiting to be formulated and sent to his/her supervisor).

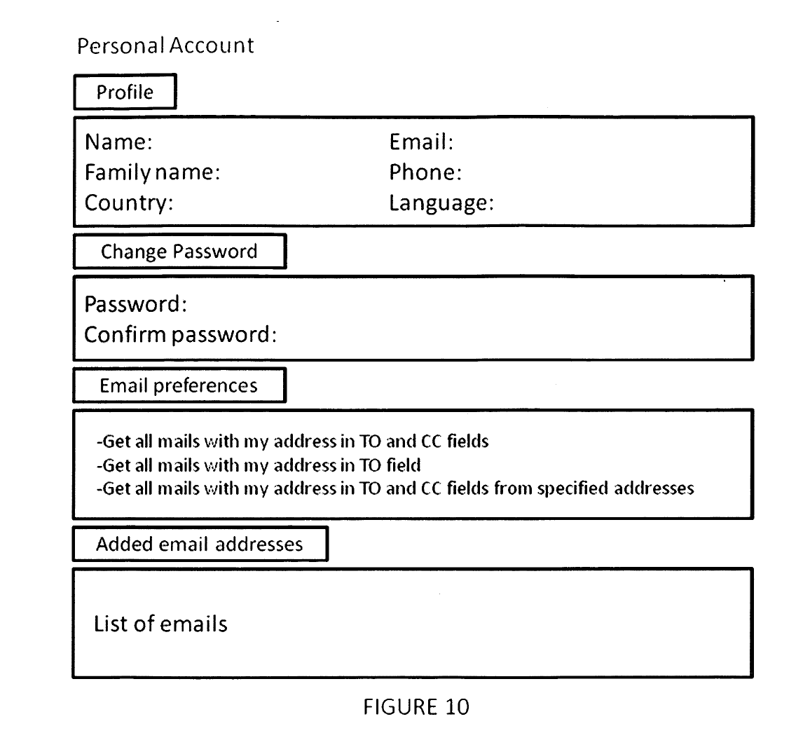

By clicking the Personal Account tab 9016, the employee is able to view the details of his/her personal account shown in FIG. 10. The information contained on this page includes the participant's name 1002, country in which he/she is located 1004, e-mail address 1006, phone number 1008, and the language in which he/she works 1010. There is also an area to record other e-mail addresses which the employee uses 1012 and a space for adding more e-mail addresses 1014. This page also includes tabs which can be clicked to find more personal account details, like keywords the employee uses 1016, a list of external contacts he/she deals with 1018, a list of other professional connections 1020; a detailed account of his/her CIMs 1022, and award packages he/she has won or is working toward 1024.

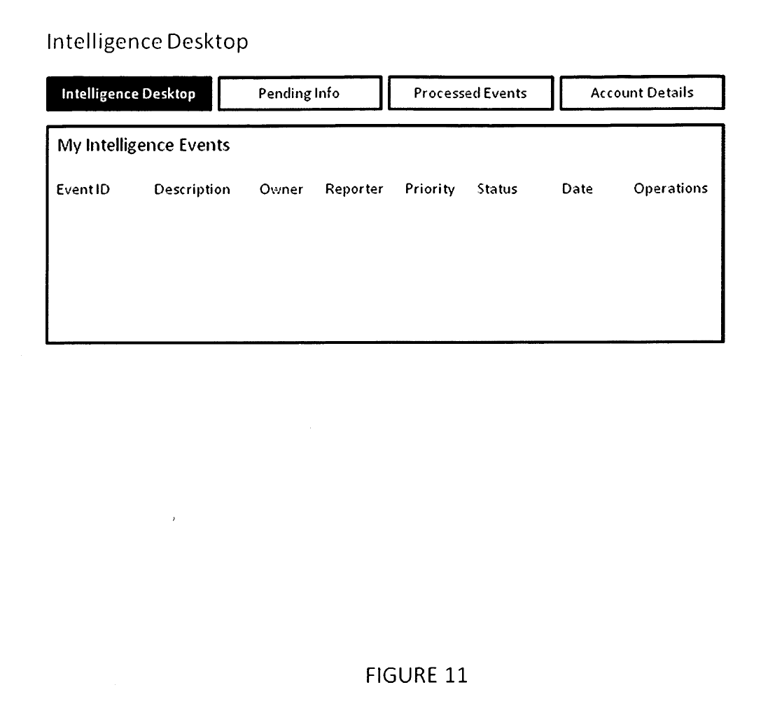

Referring now to FIG. 11, the screen shows “My Intelligence Events” 1102 for a specific period, like the past week. Under the heading of Account Details 1104, the participant finds the name of his/her primary supervisor 1106, a secondary supervisor if there is one 1108, the number of events the employee has handled 1110, the average score of each contribution 1112, and the average amount of time between the recording of the data and its submission as an intelligence event 1114. Thus the employee can see at a glance a clear picture of his/her process and progress in the organization. Below is a table 1115 which records the details of each intelligence event that the employee has been involved with 1116. Each event is assigned an ID number 1118, a brief description 1120, identification of who observed the data (either the employee or someone who reported it to him/her) 1122, the priority ranking of the data from high to low in importance 1124, the status of the report from being ready to submit to being in preparation to being just in its first raw form 1126, and finally the date on which the data was generated or reported 1128. Again, the employee is granted an immediate well-organized picture of how his/her work is proceeding in the organization.

The inventive system offers users access by subscription to multiple web crawl plug-ins, which allow the user to crawl information from the web and send it with interpretations and recommendations for appropriate action to the system without connecting directly to EIMS. Referring to Figure A, the user could surf to the CNN website, choose one article to edit and send to the system securely. By clicking the F1 icon, the user can choose to change the formatting of the webpage A1, extracting the content of the page into an editable container. The user can then highlight, delete, and/or comment on the contents of the page A2, working on the page as a Word document. He/she can also choose to remove active scripts or convert the whole site to text only for easy editing and commentary. When the editing is complete, the user adds his/her own descriptions and comments A3, and lists recommended actions/predictions/threats/opportunities before sending the information via HTTPS to the pending queue in his/her personal account.

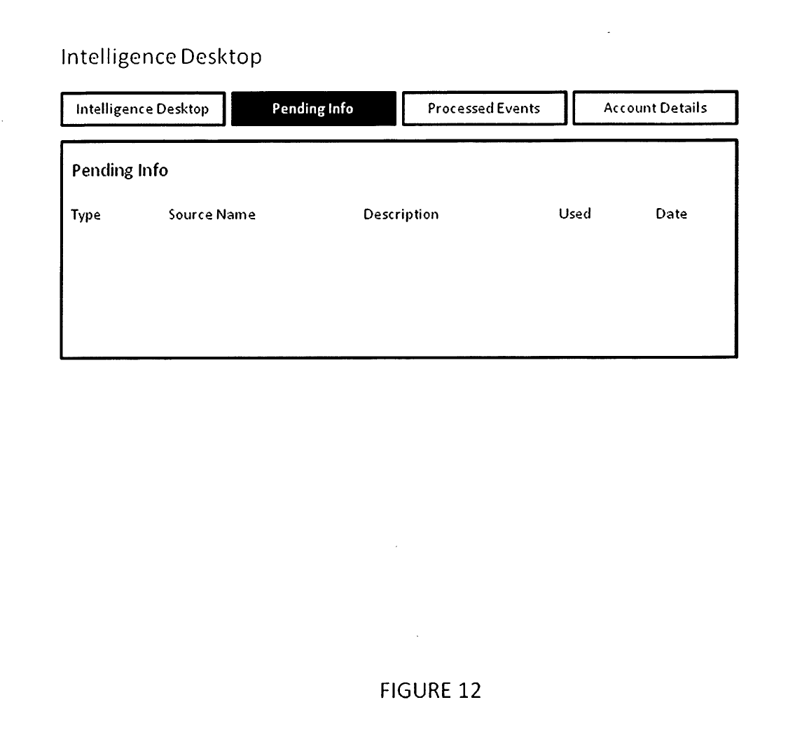

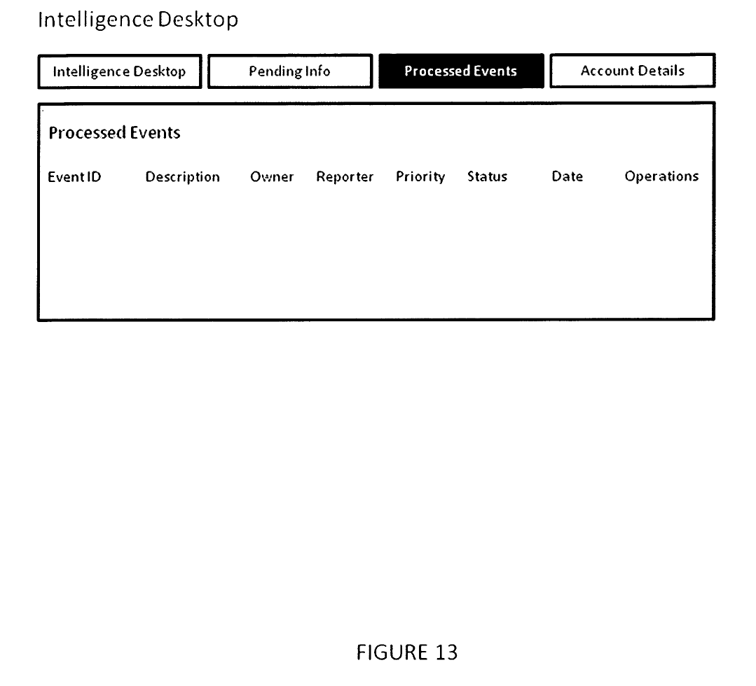

Referring now to FIG. 12, the screen shows the user's pending information 1202, which refers to intelligence sent to the office computer via cell phone, Blackberry, or other handheld device as it is generated in the field. The chart shows the mechanical source of the information 1204, namely how the information was captured and/or relayed (by html capture, Blackberry, email of a newspaper article, etc); a brief description of the occurrence 1206; the date of the occurrence or of its being entered into the system 1208; and finally, what operation the user would like to perform on the information 1210: the file can be opened and viewed, so that the user can work on it; or deleted if the user has concluded that it is of little value. If he/she clicks on the tab called Processed Events 1212, he/she is transferred to another screen shown in FIG. 13, where he/she is able to examine a list of intelligence he/she has already processed and submitted for consideration.

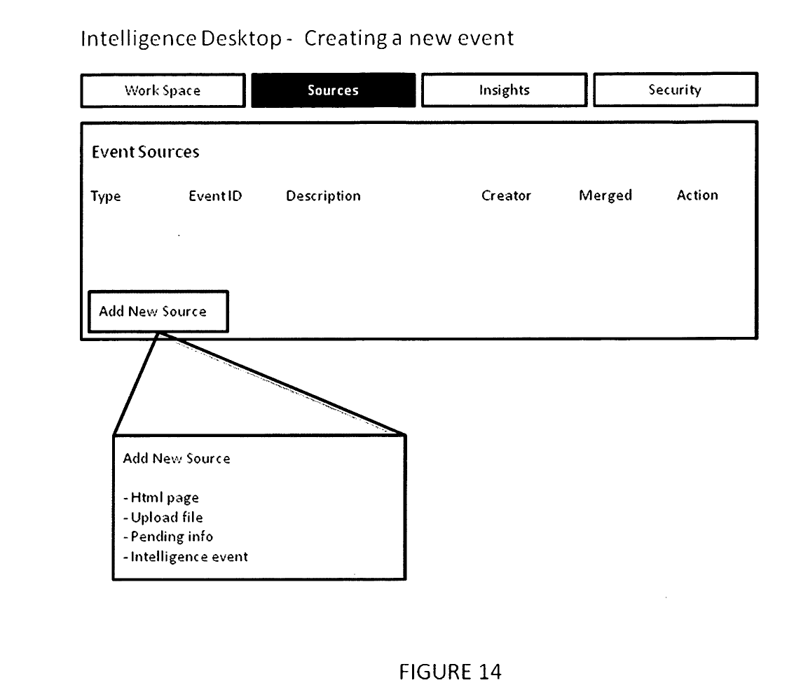

Referring now to FIG. 13, once again the user can see easily his/her recent activity. The chart 1302 displays a list of recently processed data for a defined period like “last week,” though the user could choose another period from the drop down menu. Each report submitted is assigned an ID number 1304; a description 1306; a priority ranking from high to low 1308; the current owner of the report or information 1310 (i.e., who is using the data or event as part of his/her own link; multiple positive linking of an event raises the evaluation of the event and the prestige of the contributor), the date of the event/submission of the event 1312, and event's location in the intelligence evolution map 1314. If the user clicks on the tab 1316, New Event, he/she is taken to a screen where he/she can enter data concerning another collection of intelligence data, FIG. 14.

Referring now to FIG. 14, the screen is set up like the previous screens. Above the table 1404 in the center of the screen is a box 1402, where the user can enter a descriptive title of the new event he/she wants to record and the name of the current owner of the event. In the center of the screen is a table 1404 that summarizes the user's current and recent activity. On this screen, the table 1404 records the sources of information that the user has submitted: the type of source, mechanical or human 1406; a description of the event 1408; and what action the user can take, either to view the file or delete it. At the bottom of the screen is another box 1410, where the user can add new information by uploading a file, working on pending information, or describing new intelligence data. He/she can also find tools, including templates, which can be used to contribute intelligence information to the company database; he/she can view pending information that he/she may have sent from the field via cell phone or other hand held device. The site links each user to other members of the organization, locally and abroad.

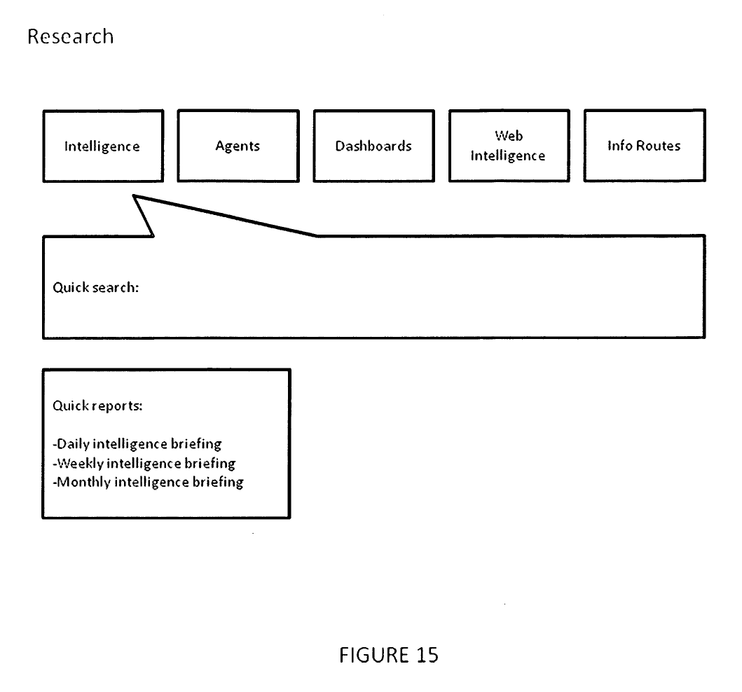

By clicking the Research tab 1414, the user is taken to a screen, FIG. 15, where he/she can quickly get current information about any company-related issue by doing a Quick Search 1502 or by accessing daily, weekly, or monthly briefings 1504, or perform other research tasks.

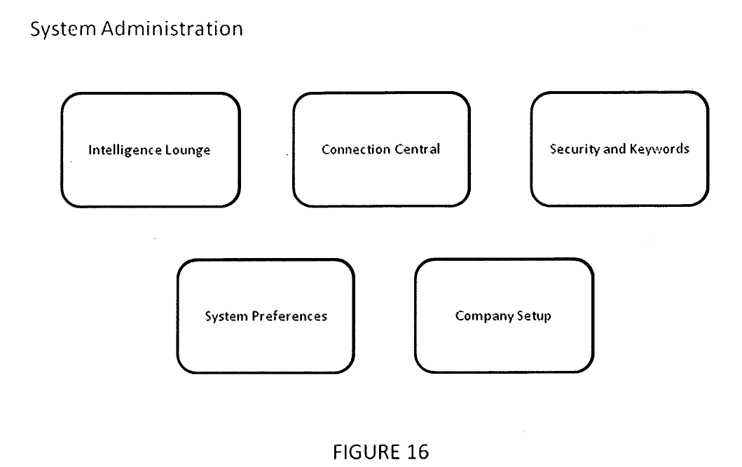

Clicking the Administration tab 1506 takes the user to a page, FIG. 16, where he/she can access administrative details about the site and the organization.

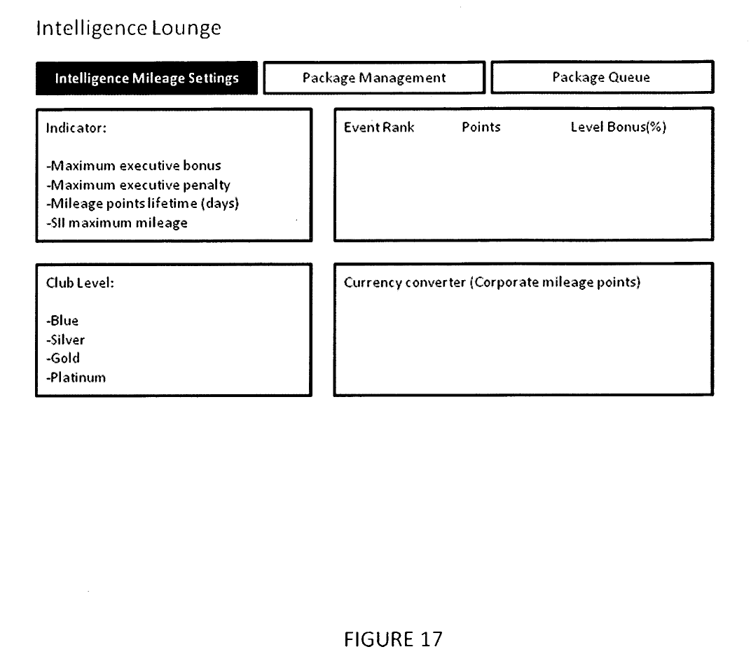

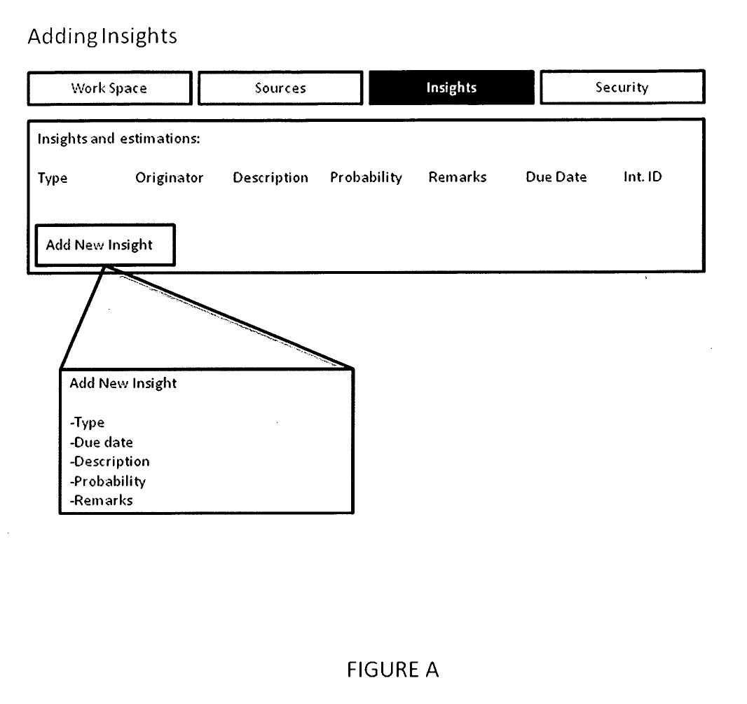

FIG. 17 is an example of what an administrative page can contain: information about Corporate Intelligence Miles 1702, how points are assigned to intelligence events 1704, how an user's status within the organization is determined 1706, and an international currency converter 1708 to convert CIMs into the appropriate dollar/pound/euro amounts.

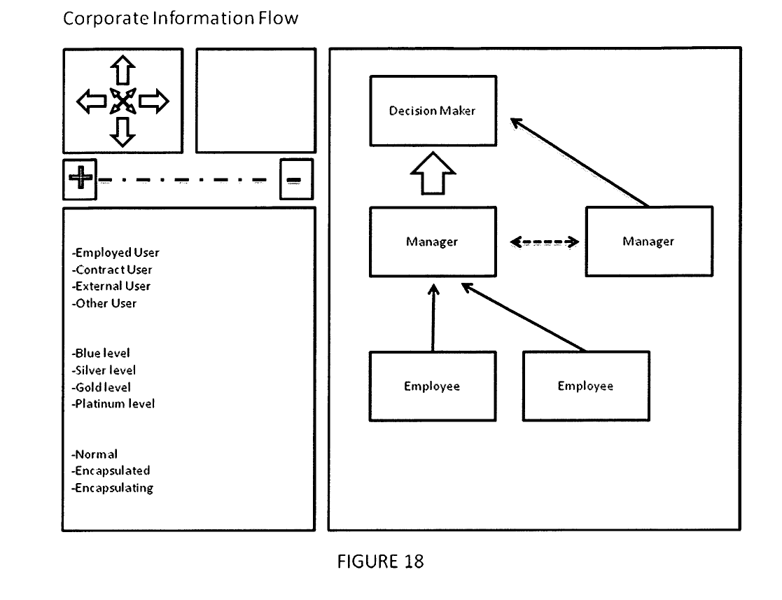

FIG. 18 shows how a competitor's Intelligence Portal pages can appear, illustrating how the Inventive Platform software might be customized for individual organizations.

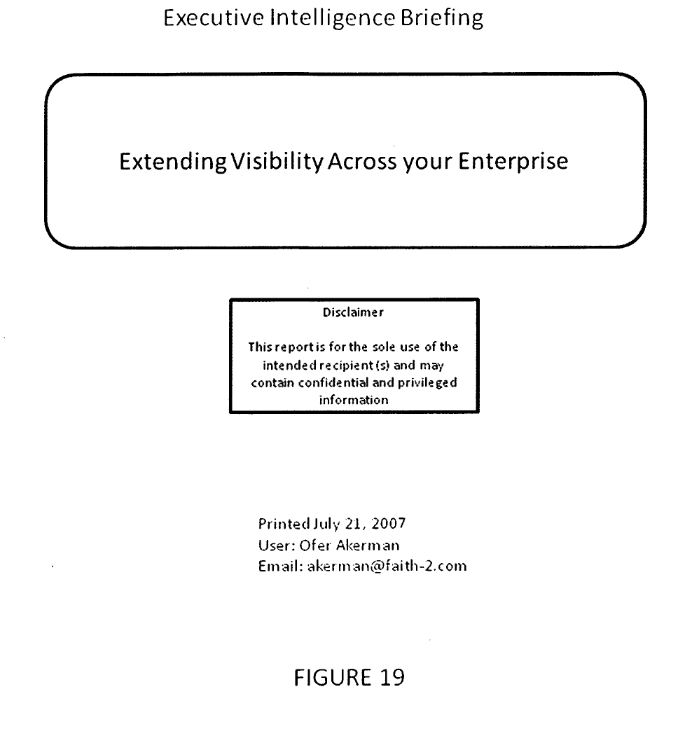

FIGS. 19, 20, and 21 illustrate what upper level managers and executives see on their screens with increased access to the EIMS. Using the Lesson Learned Report 2004, an executive can see exactly if, where, and why the intelligence is being impeded. This allows for constant improvement and cultivation of the intelligence working environment. In addition to intelligence reports (which are, in effect, policy papers) on a given subject, the inventive system provides important information about the state of the organization's knowledge/intelligence handling.

The following questions are examples of the kinds of issues which are addressed in this part of the inventive platform:
What are the international (multi-cultural) links and what languages are in use?
Which participants have as their immediate supervisor a person from a different region, country, or language?
Who is the intelligence contributor/manager/team/region of the month?
How many executive links exist for given organization?
What intelligence does the organization have on specific competitor?
What decision/actions were supported by Intelligence Threads and what type of intelligence reports were created (as a response to a Strategic Intelligence Inquiry or by Agent initiation)?
What are the intelligence processing bottlenecks in our organization/region?
Which managers mishandle the information flow?

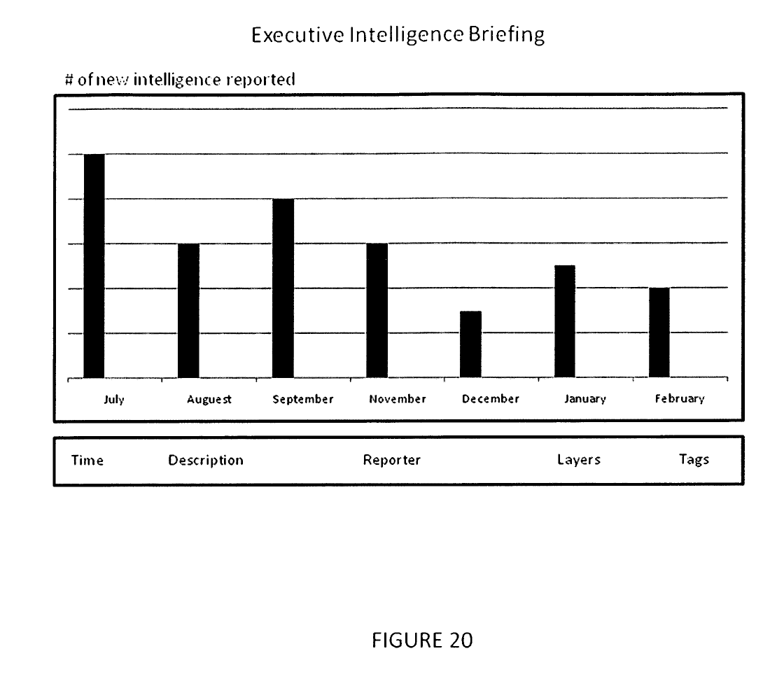

Referring to FIG. 20, upper managers, who are positioned in the company to become intelligence brokers in addition to their decision-making responsibilities, receive intelligence reports from field-level contributors on the page titled “Executive Intelligence Briefing” 2002 which is sent daily. This screen is devoted to the newest reports available. Once again the screens offer visual tracking of intelligence processes in the company (in the example in FIG. 19, a graph 1902 shows the number of reports for each day of a given week). Below the graph 2002, is a table 2004 that shows the number of the report, a description, the name of the contributor, the number of stops the information has made along the intelligence hierarchy, and the tags which might be used in the system to search and/or cross-reference the report 2006. In addition, the table adds predictions by users through whose hands the information has passed, proposes a course of action. Thus, the EIMS simplifies the process of intelligence gathering and decision making for executives, who can, with one click, read information and see who is making serious contributions to the organization's operations.

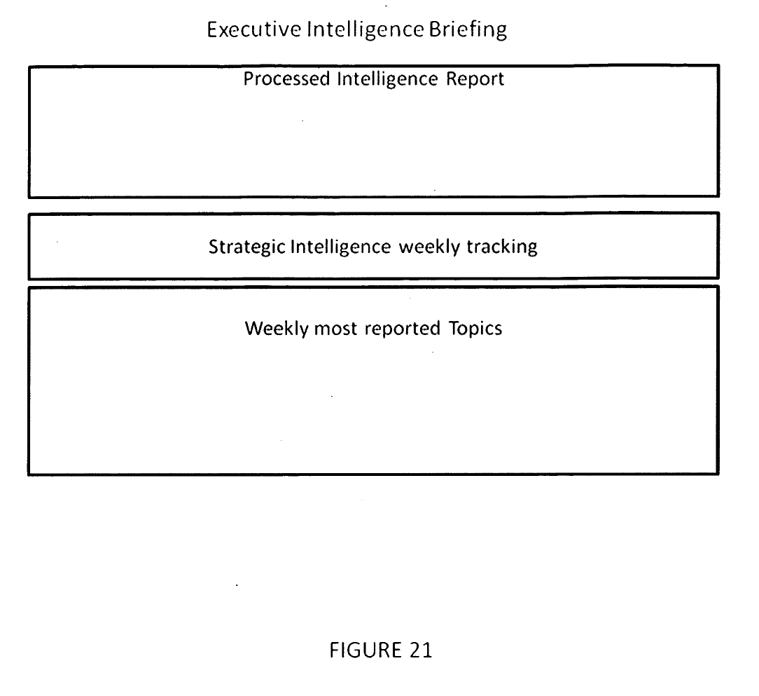

The process continues on the next screen, FIG. 21, which is devoted to recent but not the newest intelligence reports 2102. Once again, the executive can clearly see a spatial, visual image of how the intelligence is being handled and by whom, and what patterns and trends are emerging in the industry. The screen also shows the Strategic Intelligence Inquiries 2104 that the executive has sent out to the field, and when he/she expects to have the requested information in hand 2106. Further down on the screen is a pie chart 2108 showing the most active intelligence topics for the week and also a list 2109 that summarizes in words what the chart 2108 shows visually. Finally, at the bottom is a list of statistics that summarizes the executive's hierarchy: the number of reports received, the number of sources, the location of the sources geographically, the status of each reporter within the Inventive Platform's system (Gold, Silver, etc., determined by points or CIMs) 2110. Thus, the manager has at his/her fingertips an instant visual image of what exactly is the organization's intelligence reporting situation in terms of content, geography, and real time.

Referring now to Figure B, the inventive platform also provides a visual intelligence route map. Using the parameters of quality and quantity of intelligence, the system generates a chart so that executives can identify at a glance those participants B1 who are contributing constructively to the organization and those who are mishandling, misdirecting, or otherwise blocking the constructive flow of intelligence data. The width and colors of the lines B3 indicate the robustness of intelligence processing at any point along the intelligence route.

The multi-dimensional intelligence database contains only the latest version of intelligence information. The inventive system has been designed to detect weak intelligence links, thus encouraging managers to take responsibility for information they gather or refine.

Referring to FIG. 18, an intelligence evolution map (IEM) 1802, a key component of the inventive system, shows the life cycle of intelligence processing. A detailed transaction log 1804 keeps track of any processing made on a given “intelligence fragment” (defined as a vital piece of information, but without a proper context or completeness). The content of the fragment itself is restricted through keywords. The default permissions allow supervisors to see the content of his/her subordinates. Anyone in the information chain can see how many processing generations the intelligence event went through, but only authorized persons are permitted to see the content itself.

The Strategic Intelligence Inquiry (SII) 2104 is central to the Inventive System: an SII is a request by a decision maker for strategically important intelligence information sent to managers and field level contributors further down the information chain. The SII informs the organization that there is a need for information, and the responses flow back up the information chain until an appropriate, coherent policy paper is presented to that decision maker.

Referring again to FIG. 18, the Corporate Intelligence Portal (CIP) is the central repository for decision makers, managers, and field level employees. The information is presented to brokers on the information chain according to their hierarchical credentials. From the CIP, brokers can submit intelligence events, process the event further with additional interpretations, or produce decision support policy papers, while senior executives supervise the entire system. The CIP main page displays the overall corporate intelligence activities and disseminates Strategic Intelligence Inquiries. It can be customized to suit the particular needs of the organization.

An intelligence report can be initiated in response to an SII or to an independent occurrence, such as a meeting between a contributor and a competitor that took place in airport lounge, information that comes unexpectedly to a contributor's attention, or even an article in a local newspaper. The CIP includes functionalities that assist brokers in recognizing business intelligence and in processing flat information into intelligence events.

If the source of intelligence data is a web site, PDF, or Office document, the user is encouraged to highlight the relevant parts supporting or contradicting a given intelligence assumption. The source content is saved with a full date/time stamp. In the case of a web site, it is saved for offline processing via screen capture. Intelligence reports can contain several different sources to support or contradict a given intelligence assumption. Strong emphasis is put on the context of the intelligence generated by the contributor.

A logical cross link is maintained among sources of information. The sources can be viewed separately and can be referenced from more than one Intelligence Thread.

Besides intelligence reporting in response to a Strategic Intelligence Inquiry or an intelligence thread, users are encouraged to use Corporate Knowledge Templates to share new ideas and intelligence information to improve, upgrade, and maintain knowledge within the organization. The organizational knowledge templates are managed by direct links and not via hierarchical levels as intelligence threads.

There are two types of templates: (1) system templates provided by the inventive system, and (2) private templates, created by company users. Contributors can use the predefined organizational knowledge templates or use a highly functional, user friendly “form builder” to define their own proprietary knowledge forms.

The Connection Manager allows a contributor to see his/her links graphically. Working details, like the amount of correspondence, CKT, etc., are provided for every link. With the Connection Manager, the user can refine his/her contact network, deleting old connections and establishing new ones.

A contributor may have more than one supervisor. While processing intelligence data, the contributor decides to which supervisor he/she wants to send the resulting intelligence event. Using the Connection Manager and a two-way-handshake authorization process, the organization's information flow routes can be defined.

The Research Center provides broad measurement tools, statistics, and data mining. It also includes drill down/drill up options and advance reporting capabilities. The Research Center contains a comprehensive set of reporting tools that gives decision makers the ability to produce intelligence papers on topics of interests and identify information handling bottlenecks. The intelligence reports are customizable and can be produced in PDF/HTML or as Word documents.

Some of the predefined reports include:
Identification of information mishandling;
Identification of managers who sabotage collaboration within the organization;
Identification of creative and non-creative teams;
Identification of the robustness of multicultural links;
Lesson Learned Report—intelligence handling structure; and
Identification of low quality intelligence events that have risen more than two links.

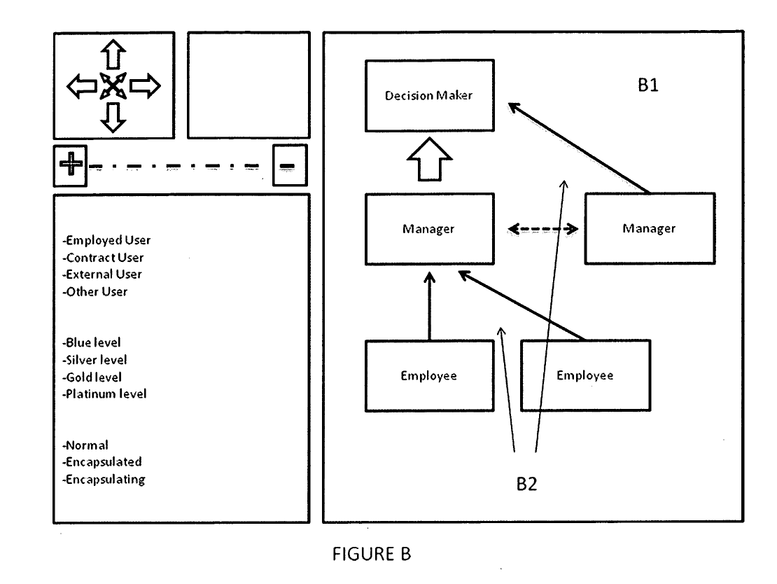

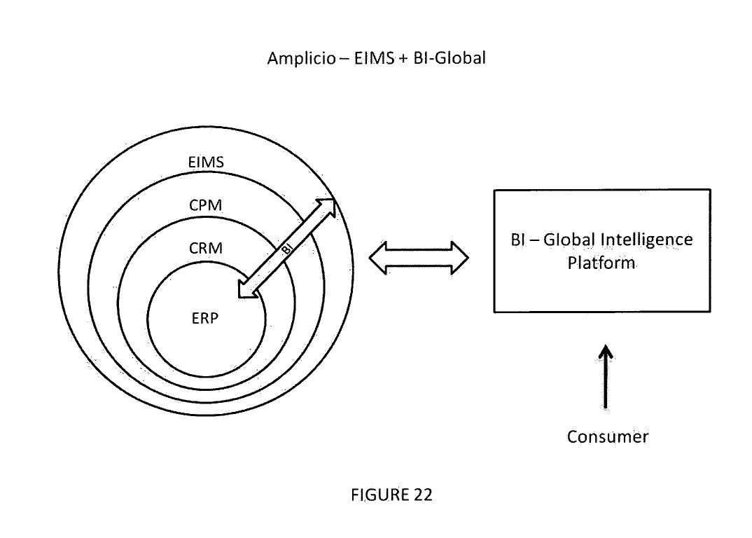

Referring now to FIG. 22, the inventive system combines two complementary subsystems: EIMS 2200 and a BI Global ITP 2202, hereinafter known as BI Global, an intelligence trading and intelligence broker management and screening system. EIMS 2200 captures contributors' experiences, knowledge, understanding, and interpretation of structured and unstructured data and distills these into high quality intelligence events of use to support strategic decision makers and to define a broader contextual awareness for organizations using the system. The BI Global ITP 2202 allows information consumers to request customized intelligence reports; and information brokers with relevant information to sell what they know.

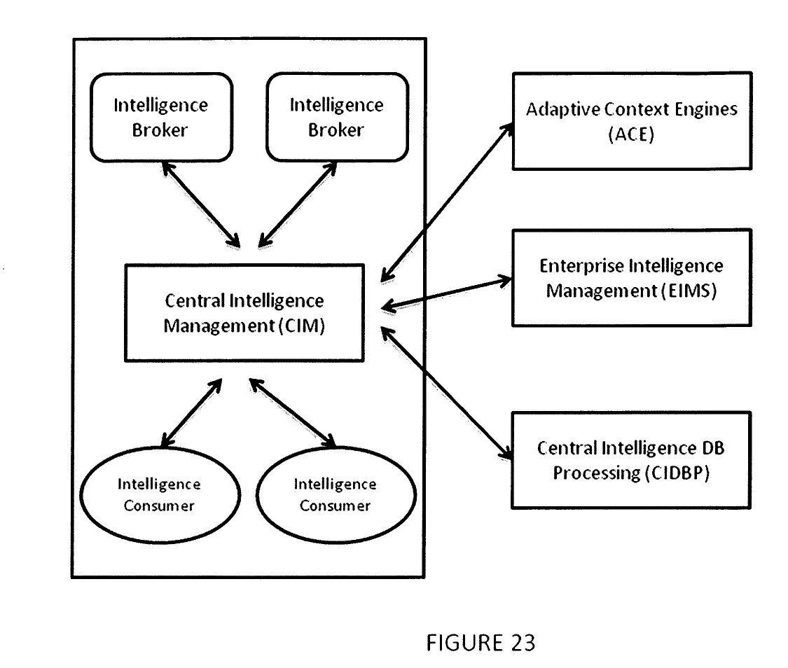

Referring now to FIG. 23, the intelligence consumer 2304 is an organization (including but not limited to manufacturers, public and private service providers, social clubs, charities, philanthropic and other non-profit organizations, religious organizations, unions, sports teams, incorporated individuals, school districts, colleges and universities, research companies, consulting services, local governments, the arts and entertainment industry, hospitals and other components of the health care industry, and banks and brokerage firms), which is seeking customized information on any issue, and which requests particular information and, through BI Global's unique intelligence management process, acquires the information needed.

The intelligence broker 2304 is any person in possession of intelligence assets (for example, particular information, experience, expertise, or a unique perspective), who wants to sell the above in direct response to a request from an intelligence consumer 2302, or as an unsolicited intelligence report. The brokers 2304 come from the upper echelons of management; they receive information from sources inside and outside the organization. Internal sources are usually members of the organization whose experiences, interpretations, and/or analyses of information have been distilled and refined into contextually relevant intelligence events; the members receive bonuses and/or other incentives to supply information and are ranked internally on the quality and quantity of information they offer. The ITP converts the events into intelligence assets and the broker 2304 can now use the newly-formed commodity to construct his/her intelligence reports in response to consumer queries. The broker and his/her reports are ranked by consumers who are in turn ranked by the broker. He/she increases personal visibility and prestige by taking part in intelligence transactions. Thus, BI Global 2202 puts specialists and experts in any area at the disposal of its subscribers who would otherwise be without immediate access to such resources. Intelligence is used via ITP as a valuable asset that can be traded like other material goods. The consumer uses the Central Intelligence Hub (CIH) 2306; and BI Global 2302 centralizes the BI broker's information, thereby providing easy marketing for the broker 2304 and easy access for the consumer 2302.

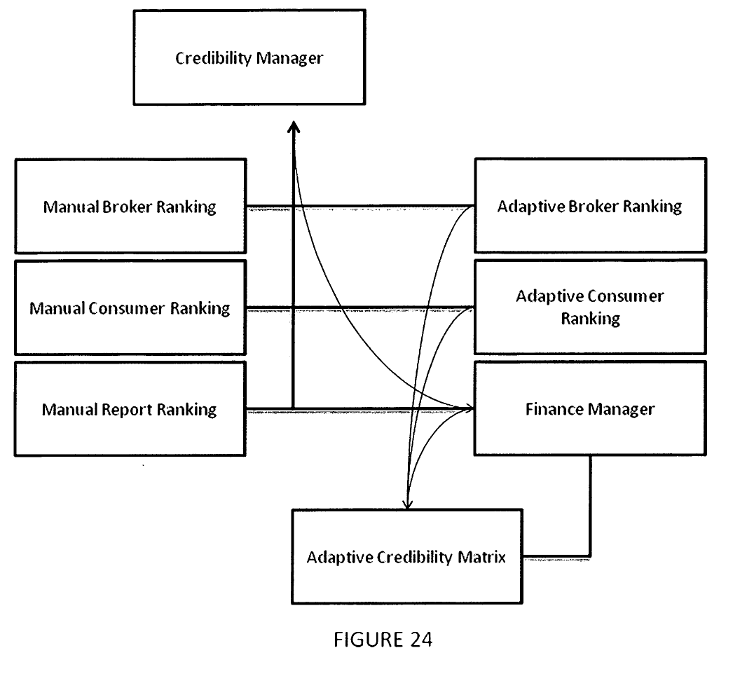

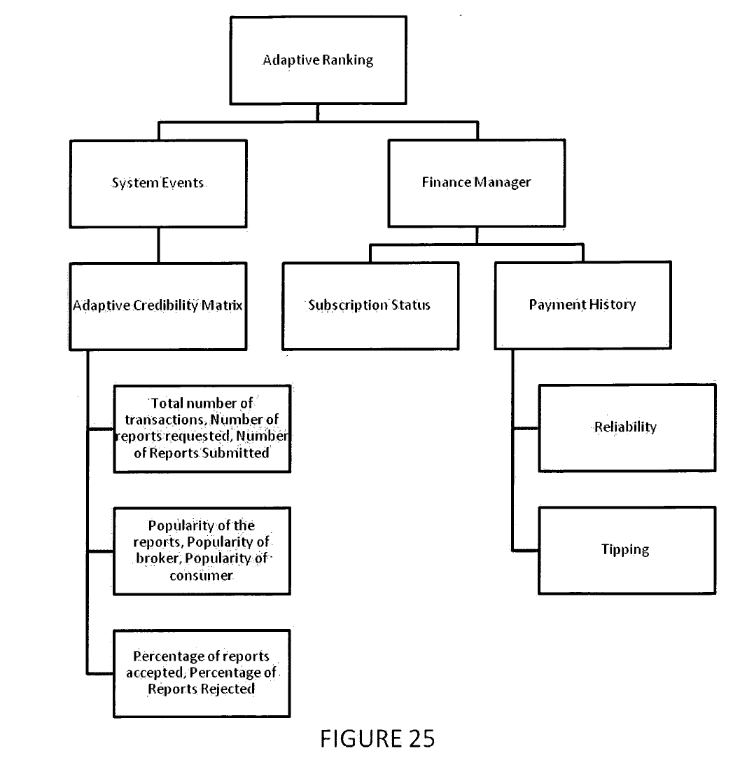

The core of the system is a strong User Management and Profiling algorithm shown in FIGS. 24 and 25 that evaluates and scores the validity of the report, the quality of the broker, and the trustworthiness of the consumer. The system's business logic includes advanced context analysis engines which interpret and process intelligence reports according to industry-specific standards, and then construct a wider context for business intelligence.

BI Global service is based on a monthly subscription fee, for which BI brokers and consumers are granted access to the BI Global community and the database, and to resources that allow advanced BI commerce between intelligence brokers and intelligence consumers, and between BI Global and its brokers and consumers.

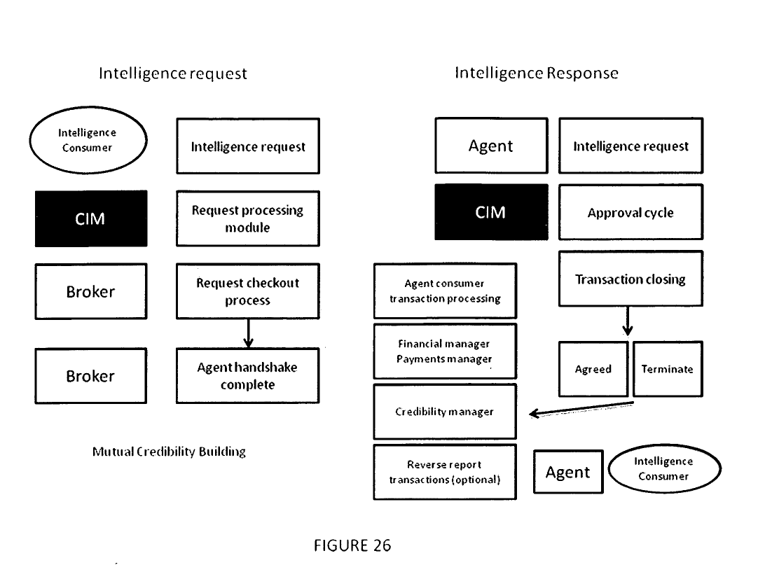

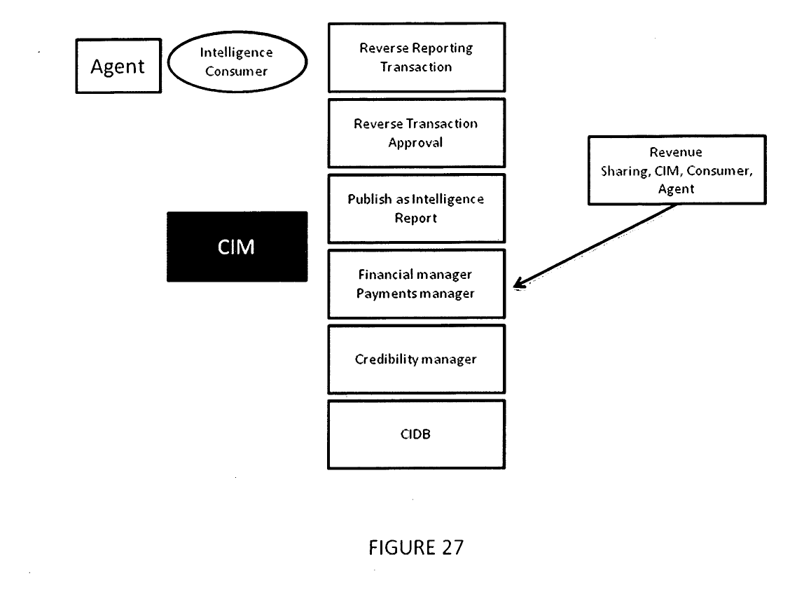

Referring now to FIGS. 26 and 27, sales are conducted by forward and reverse bidding: in forward bidding, a consumer 2602 initiates a bid for a customized report; and in reverse bidding, consumers 2710 and brokers 2712 agree to offer a previously purchased report for resale.

BI Global's trading process involves several steps with unique components, including an Intelligence Template Generator, Adaptive Ranking, and a virtual trust account handled by the Finance Manager to oversee the transactions. Moreover, the whole system offers all participants the ultimate in confidentiality.

The ITP has a variety of revenue-generating opportunities that can make the system profitable in a short time. For example:
A progressive annual subscription fee for brokers;
An annual subscription fee for consumers (including but not limited to businesses, governments, and other organizations or individuals) for access to the intelligence database and for submitting intelligence requests;
An Intelligence Transaction Commission;
A Reverse Intelligence Transaction Commission;
A vehicle for doing background checks on Brokers; and
A report commission to Brokers.

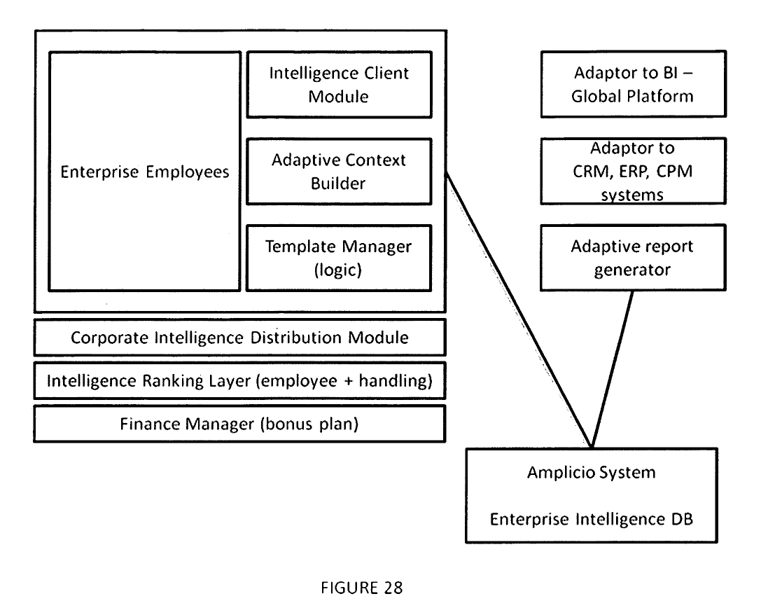

The main components of the EIMS are shown in FIG. 28. The Intelligence Client Module 2802 recognizes that the best intelligence brokers are the members of the organization. This module offers any member the chance to gather and organize his/her experiences, add personal interpretation, and using the appropriate template (provided by the Template Manager 2804) send his analysis and recommendations up to the next link in the chain of command through virtual intelligence channels.

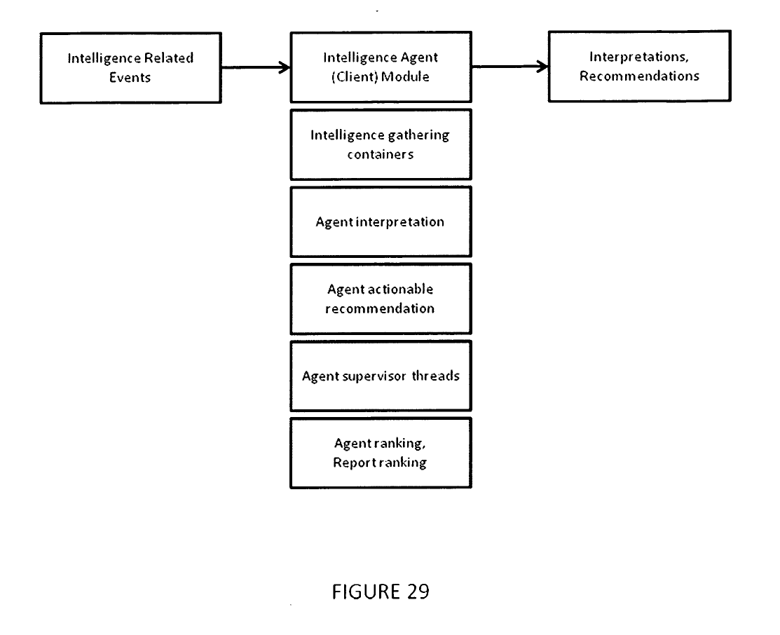

Referring to FIG. 29, the EIMS Intelligence Broker Module 2900 includes four steps: information gathering 2902, template validation, broker interpretation 2904 and recommendations 2906, and supervisor threads 2908 where the supervisor can request clarification. Moreover, the adaptive ranking module 2910 rates the brokers and the intelligence reports, and because it is connected to the Finance Manager, it can then implement bonuses to brokers for excellent work.

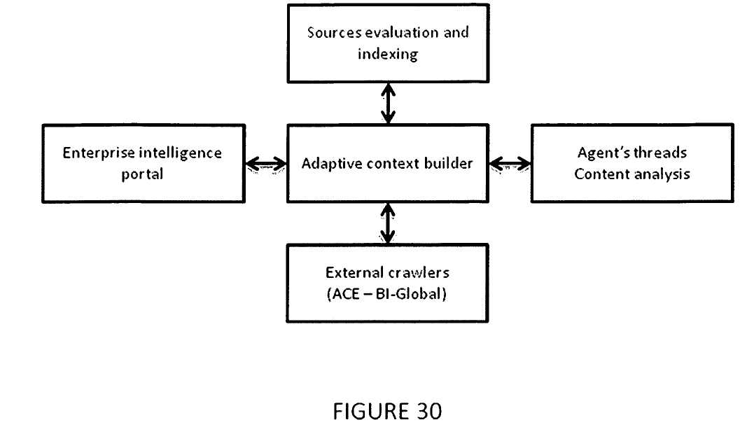

Referring now to FIG. 30, the Adaptive Context Builder 3000 analyzes the brokers' reports 3002 and sources 3004. It combines with external data crawlers (known as ACE 3006) to build the backbone of the organization's intelligence portal 3008. The Adaptive Context Builder 3000 works at the broker/organization level. The enterprise intelligence portal 3008 is an excellent source of information for an organization because it engages in ongoing intelligence gathering and analysis.

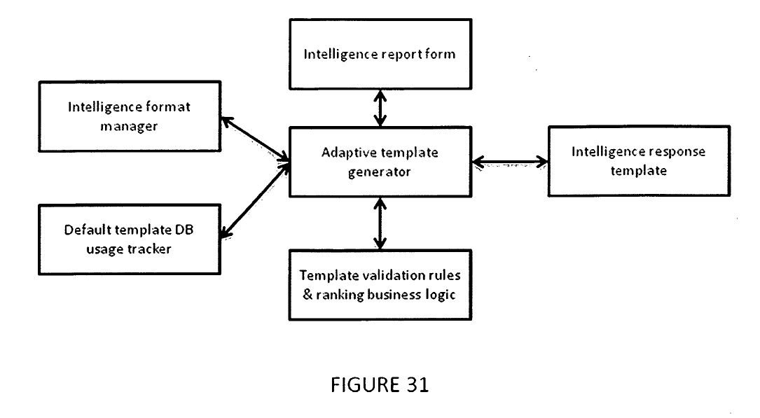

Referring now to FIG. 31, the Adaptive Template Generator 3100 illustrates the intelligence structure that brokers are required to follow, defining the rules and the business logic 3102 that must be applied and validating the template 3104 accordingly 3102. The template 3104 demonstrates the fundamental form 3106 of the intelligence report, which can be customized for different purposes. The templates 3104 in this module give structure to unstructured data for further analysis, evaluation, and distribution. EIMS also supplies default templates 3108 that can be used by different organizations according to their needs.

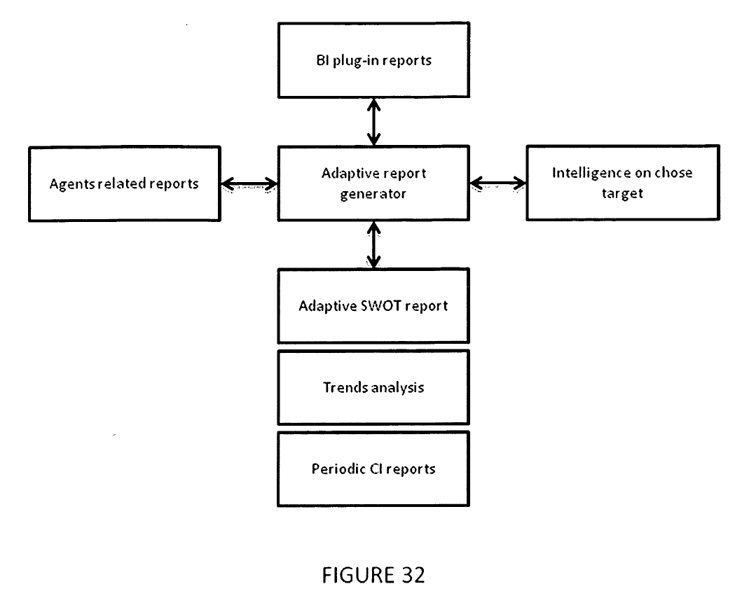

Referring now to FIG. 32, the EIMS Adaptive Report Generator provides consumers with access to reports in four abstract classes whose schemes can be modified according to their needs. The adaptive SWOT (strengths, weaknesses, opportunities, threats) reports 3202 offer wider analyses of all intelligence in the system and are useful for decision-making, meeting preparation, strategy-building, and evaluating competitors. Specific Target Intelligence 3204 can be directed at well-defined objects. The EIMS Adaptive Report Generator 3206 can be connected to existing BI applications 3208 such as CRM for advanced multi-dimensional analysis. Intelligence consumers can combine these reports in any way that improves their competitive positioning and creates maximum advantages for them in Asymmetric Business Warfare.

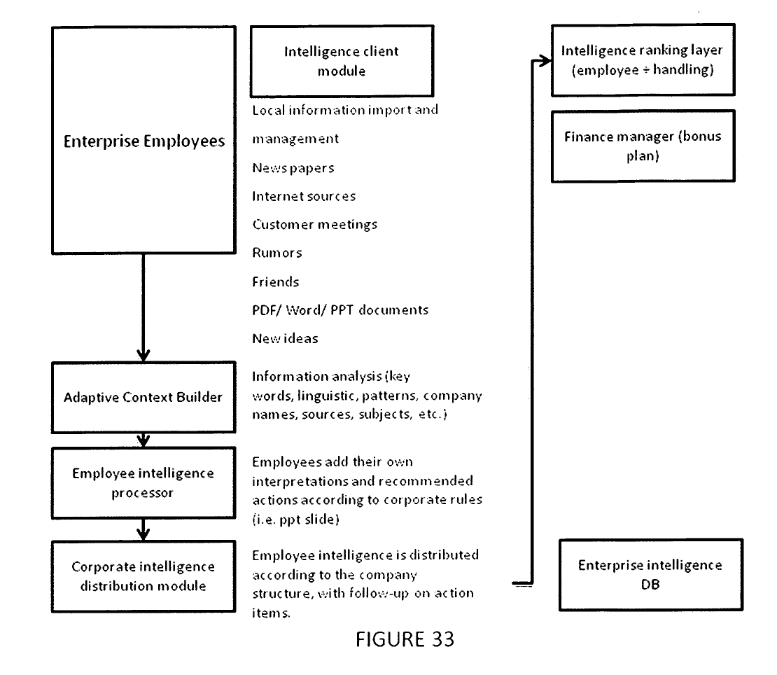

Referring now to FIG. 33, the Corporate Intelligence Distribution Module 3302 disseminates information within an organization. Using a predefined chain of command, module 3302 sends reports and then tracks and records the actual attention that supervisors pay to specific intelligence. It is connected to the Intelligence Ranking layer 3304 and the Finance Manager 3306.

The Intelligence Ranking layer 3304 evaluates and rates intelligence brokers, intelligence reports, and handling of the reports. Layer 3304 also provides overall verification that intelligence management within the organization is accurate and effective. The purpose of the Finance Manager 3306 is in part to offer financial incentives to potential intelligence brokers.

Continuing to refer to FIG. 33, the EIMS work flow is illustrated. (Note that at any stage in the intelligence processing cycle, EIMS can issue alarms concerning mishandled information.) The broker/contributor 3308 uses the client module 3310 to input intelligence data. The employee simply chooses a template and fills it in. The information is then published by the EIMS Corporate Intelligence Distribution module 3312, where the intelligence context engines analyze it and feed it into the Enterprise Intelligence Database 3314. The Intelligence Report is then examined by the Internet Link Supervisor 3316 who can comment, request clarification, and rank the report and the interpretation therein. The ranking, moreover, is a mutual process: the broker who created the report can also rank the organization's handling of his/her work.

Referring again to FIG. 4A, for example, consider a fictitious a lumberyard, Wood 'n Stuff, that has been flooded. Six employees are on the scene when the flood occurs. Employee A thinks that the flood is solely the result of heavy rains. Employee B, however, feels that the lumberyard is located too close to the river and is therefore always in danger of being flooded. Employee C thinks that neither location nor weather is the problem: the lumber was not stored properly, in a way that would minimize damage. Employee D believes that some of the lumber can be salvaged. Employees E and F are concerned with losing their jobs and so leave the lumberyard during the flooding and go to the job bank to look for new employment opportunities.

Employees A, B, C, and D talk with the foreman who tells them to write up their observations and ideas, using a form he provides. He then reads the reports and, using and summarizing the information the employees have provided, writes one of his own. He concludes that while it may be advisable to relocate the yard at some time in the future, for now it would be enough to improve protection methods. Further he suggests that some of the damaged wood could be used to build quirky, campy pieces of furniture to sell on eBay. He presents his report to the owner of the lumberyard, who promotes him to assistant manager, gives bonuses to the participating employees, and tells the two who left during the crisis that they are on probation. The owner, moreover, writes about the event and considers that it may be of help and value to other lumberyard owners.

Six months later, another lumberyard 500 miles away is flooded. The owner of the second lumberyard is young and inexperienced and goes online to find out how other lumber-yard executives deal with this kind of event. He finds that the owner of Wood 'n Stuff has the information he needs and he asks what it would cost to receive a detailed report.

As another example, suppose that NewCo, a security company, wishes to assess the cost/benefit proposition for ISP-level anti-Trojan services. The existing analyst reports identify the size of the market and the need for security. Internet research shows that many ISPs offer a variety of security services, such as parental controls. But in order to define the cost-effectiveness and profit potential for providing a package of these services, NewCo needs more practical and specific intelligence. For example:
What is the ISP deployment cost for SMB security services?
What are the ISPs for these services?
What is the business model that allows both parties to make a profit?
What are the performance expectations?
Does any competitor offer the same package of services?

This kind of detailed information is not usually found on the Internet or in general analyst reports, but anyone who works in development, sales, or security management for an ISP company would be able to provide it. BI Global offers a venue for this intelligence exchange.

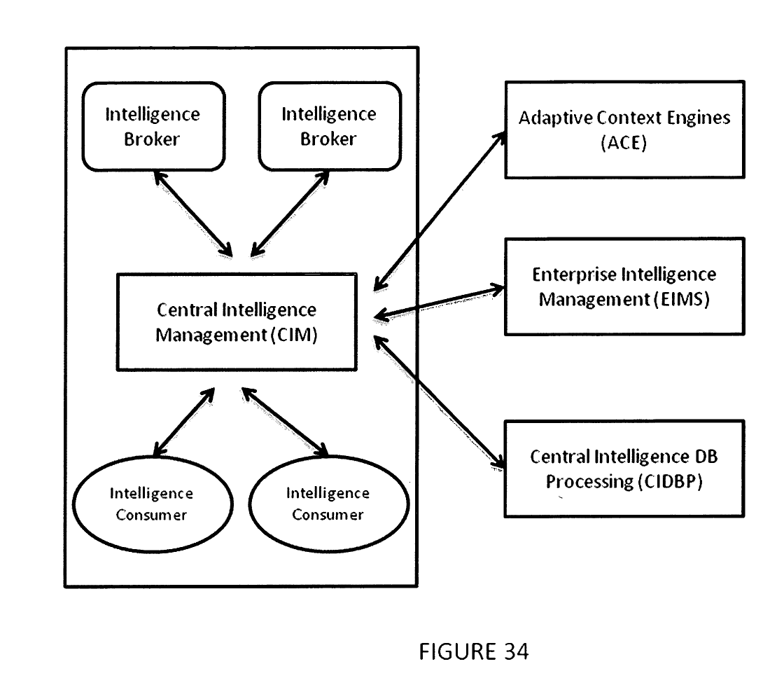

BI Global's CIH, shown in FIG. 34, contains core modules that enable secure and easy intelligence trading between brokers 3404 and consumers 3406.

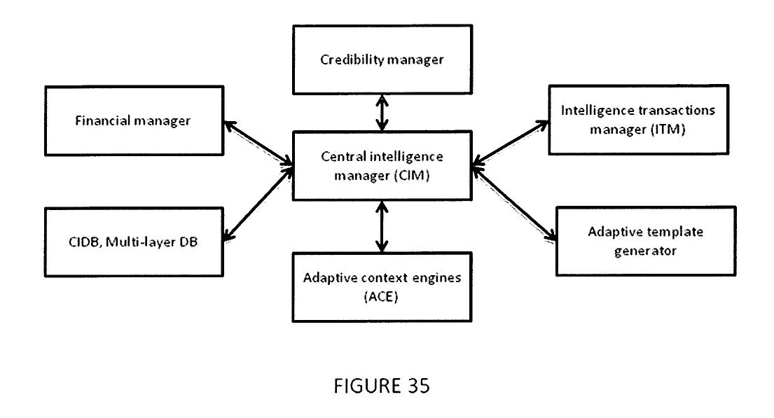

Referring now to FIG. 35, CIH 3500 also includes unique subsystems for ranking brokers 3502, managing intelligence templates 3504, following up on transactions 3506, and managing the financial records associated with each sale 3508. The major kinds of intelligence transactions supported by the system are the following:

Consumer to Broker: The consumer requires intelligence about a specific issue; he sets a price and the distribution constraints. Several brokers see the request and offer their reports. See the detailed description below.

Unsolicited Broker Reports: A broker can write a report on an unsolicited basis and offer it to other subscribers. Based on his ranking, the broker can set his price and sell the report exclusively or non-exclusively to as many clients as he wishes. A profile-based analysis is offered to consumers who buy the report: “Organizations who bought this report were also interested in . . . .”

Reverse Bidding After a report has been purchased by a consumer, he and the broker may agree to offer the report to the community for resale. The consumer and the broker then share the revenue from each subsequent sale.

FIG. 35 is a block diagram of the CIH's 3500 main components. The CIH 3500 inputs intelligence-related events into the CIDB database 3510 which then generates a unique source of information for BI Global subscribers.

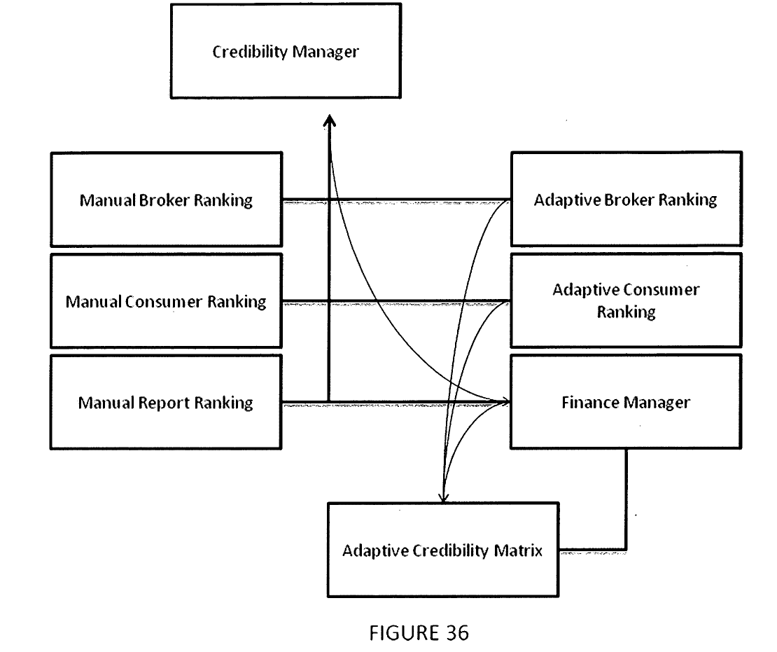

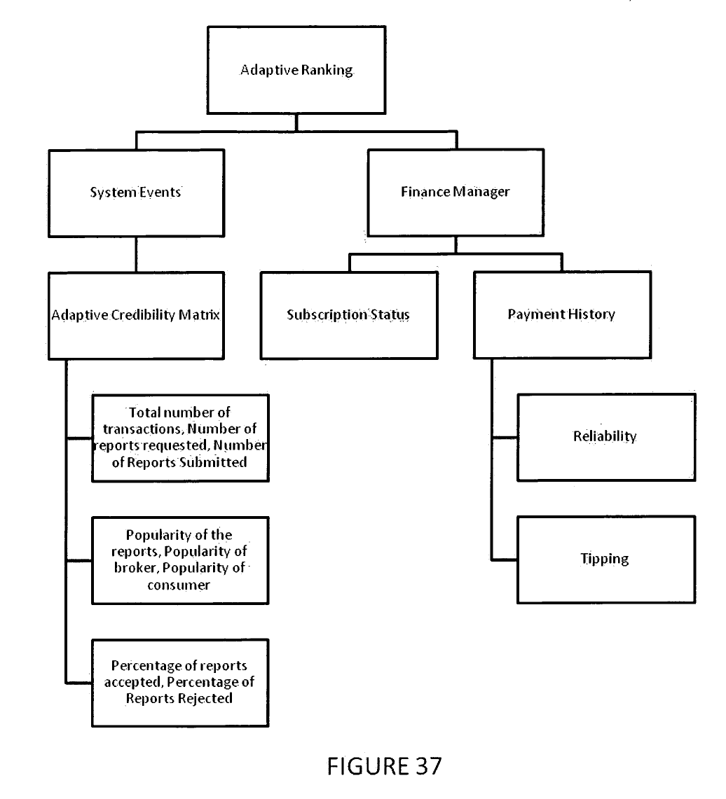

FIG. 36 is a block diagram of the Credibility Manager 3602. The Credibility Manager 3602 handles consumer and broker rankings based on adaptive parameters 3604 and/or manual parameters 3606. Manual ranking 3606 is defined by the community members who rate individual brokers 3608, individual consumers 3610, and individual reports 3612. Adaptive ranking 3604 is derived from broker 3614 and consumer 3616 behavior profiles related to system events, shown in detail in FIG. 37.

Referring now to FIG. 37, these events include financial transactions overseen by the Finance Manager 3702, including subscription status 3704 and payment history 3706; for example, is the consumer reliable 3708 and does he tip the brokers he works with 3710. The Adaptive Credibility Matrix 3712 summarizes consumer/broker behavior; for example, the total number of transactions associated with various brokers and consumers along with a breakdown of reports submitted and reports requested 3714, the relative popularity of various brokers, consumers, and reports 3716, and the number of reports accepted and/or rejected 3718. The Credibility Manager 3602 connects to the Finance Manager 3618, moreover, in order to identify financial events related to consumer credibility; for example, does the consumer routinely ask for and then reject reports, does he make only the initial payment, fail to tip, and so on.

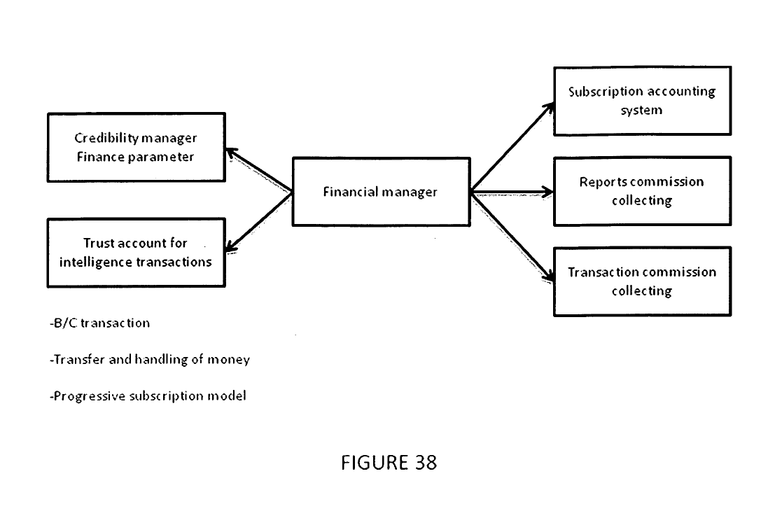

Referring now to FIG. 38, the CIH Financial Manager 3800 handles all financial matters and is tightly bound to the business model. It maintains subscription records 3802. Abstract parameters like transaction fees 3804, service costs, and revenue models are integral parts of the Finance Manager 3800. The Finance Manager 3800 functions as a virtual trust account 3806 that oversees broker/consumer deals 3808, the transfer and handling of money 3810, and the progressive subscription model 3812. It is part of the Adaptive Credibility mechanism.

The BI Global Subscription Manager handles subscriber accounts and profiles, and introduces a unique feature called Progressive Subscription, which reduces the annual subscription fee as the subscriber's activity and ranking increase. Active brokers and consumers no longer pay any yearly fee once they reach and maintain a predetermined level of activity.

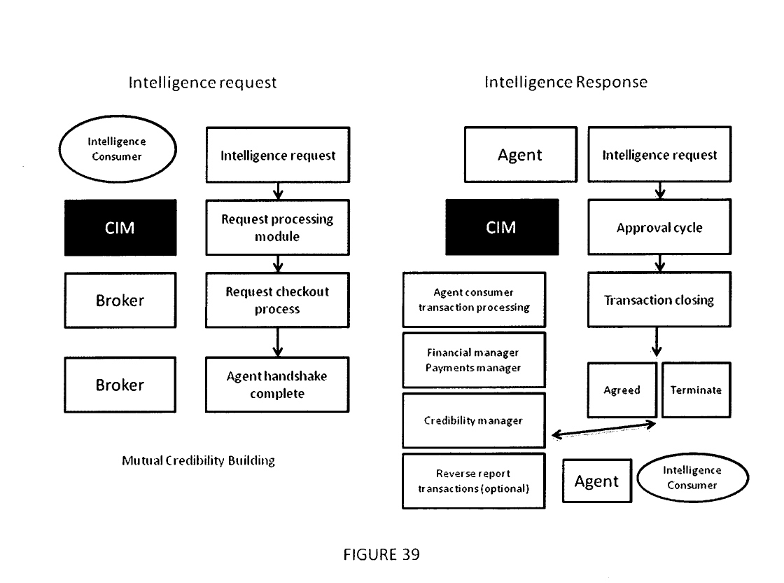

The following section demonstrates in detail an Intelligence Trading Transaction process between a broker and a consumer, illustrated in FIG. 39.

The intelligence request step 3902: An intelligence consumer 3904 wants to investigate the profit potential in developing an anti-virus capability for a storage provider like EMC. The consumer starts by choosing an XML template or using the Dynamic Template Generator to fill out his intelligence request. The basic query template may include the following fields: the category of the request, the text of the request, the elements required in the answer, the desired structure and length of the report, broker constraints which limit the publication of the request to certain brokers only (for example, only brokers with a specific ranking, only brokers validated by the system, only brokers with company XXXX in their profiles), the final date to submit the answer, and the price that the consumer is willing to pay for the information. The broker investigation payment is paid when the broker has investigated the query. The reverse bidding constraint (whether the report will be offered for resale or not) is established, and the required response format (which is part of the template generator) is settled on.

When the intelligence request is submitted, CIH 3910 publishes it anonymously to the relevant brokers 3906. Those brokers who have the information and want to sell it can investigate the request further 3908. At this point, the broker and the consumer can exchange clarification notes, and agree on the template to be used in the response, on the number of clarification threads, and on the reverse bidding terms.

When the consumer is prepared to proceed with a broker, he/she can move on to the virtual handshake 3912 that seals their agreement. The broker can immediately begin formulating the report, as the downpayment is transferred into the Trust Account and the transaction is registered and tracked by CIH's Transaction Manager 3914 and Finance Manager 3916.

The intelligence response 3918: the broker submits his report using the chosen template. The system automatically verifies that the template has been properly completed with all mandatory fields filled in (see Template Generator Module, FIG. 31) and notifies the broker before sending the response to the consumer.

When the consumer receives the report during the response approval cycle 3920, he can ask the broker for further clarification.

The transaction is completed 3922 in one of two ways: Agreed 3924, whereby the consumer accepts the report and pays the balance owed to the broker, including a tip; or Terminated 3926, whereby the consumer rejects the report and is unable to download it. The broker retains the downpayment.

If the parties agreed previously to sell the report in Reverse Bidding 3928 and share the revenue, the report is published for the community with a price attached.

Once the transaction is concluded, the broker and the consumer issue rankings for each other and for the quality of the report. This process is handled by CIH's Credibility Manager 3930 and helps to maintain high quality dealings among consumers and brokers. As part of the mutual ranking, both the broker and the consumer can score the resources, especially those from the Internet, and the BI Global ACE engines generate dynamic indices based on these resources for community information. This, of course, automatically increases the ranking of the parties by the Credibility Manager.

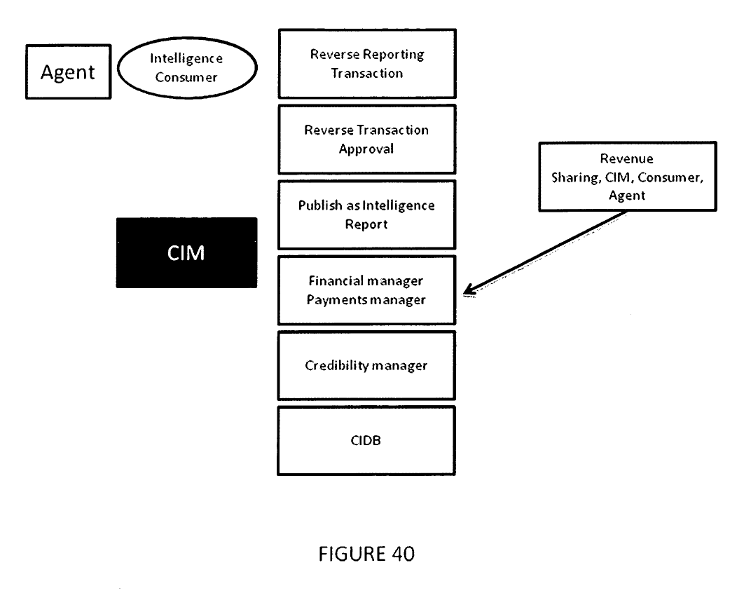

Referring now to FIG. 40, the CIH Financial Manager 4000 transfers the commission money and any shared revenue from reverse transactions in accordance with the automatic deduction system defined on the subscription profiles of the persons involved.

The bidding among brokers to answer a particular intelligence request is performed using the BI Global System's dedicated mission procedure which processes the bid request and designates a group of brokers most likely to have the necessary information. The bid is then published among those brokers, together with a detailed profile and ranking of the consumer. Brokers who decide to participate in the bidding upload their reports with the price tag to the BI System. Using contextual intelligence engines that cross-reference information from other reports on the same topic and industry, the system constructs a broad intelligence report. The individual reports and the broad context report are then indexed and stored, and an abstract of each is sent to the consumer, along with the price tags and the brokers' profiles and rankings.

Since other modifications and changes unique to different operating requirements are apparent to those skilled in the prior art, this invention is not considered limited to the examples chosen for the purposes of this disclosure and covers all changes and modifications which do not constitute departures from the true spirit and scope of this invention.

Having thus described the invention, what the inventor wishes to protect by Letters Patent is presented in the following appended claims.

What is claimed is:

1. A method for transforming information into intelligence events, the steps comprising:
a) providing an enterprise intelligence management system (EIMS) for collecting intelligence data;
b) interpreting said intelligence data;
c) evaluating said interpreted intelligence data; and
d) encapsulating said intelligence data and interpretations thereof into intelligence events.

2. The method for transforming information into intelligence events in accordance with claim 1, the steps further comprising:
e) providing an intelligence trading platform operatively connected to said EIMS, for trading said intelligence assets with consumers.

3. The method for transforming intelligence events into intelligence assets in accordance with claim 1, wherein said EIMS comprises at least one of:
i) an enterprise employee module for gathering information, validating templates, allowing employee interpretation and recommendations, and providing supervisor threads for clarification;
ii) an intelligence client module for allowing brokers to gather, manage, and interpret said intelligence events;
iii) an adaptive template generator for defining the intelligence scheme and logic followed by said brokers;
iv) an adaptive context builder for analyzing threads and sources of said brokers;
v) an intelligence distribution module for distributing intelligence within an enterprise;
vi) an intelligence ranking module to evaluate and rate the interpretations of brokers, the intelligence reports, and the efficiency of the handling thereof; and
vii) a finance manager module to provide brokers with financial incentives, to disburse commissions, and to manage a virtual trust account for ensuring completion of a transaction between a consumer and an intelligence agent.

4. The method for transforming information into intelligence assets in accordance with claim 2, wherein said intelligence trading platform comprises at least one of:
i) a central intelligence hub (CIH);
ii) an adaptive context engine;
iii) a credibility manager;
iv) an adaptive template generator; and
v) an intelligence transactions manager for enabling a consumer to find information derived from an individual interpretation in response to a given intelligence request.

5. The method for transforming information into intelligence assets in accordance with claim 2, the steps further comprising:
f) generating an adaptive report in response to a request of a consumer.

6. The method for transforming information into intelligence events in accordance with claim 1, wherein the Internet is used to perform at least one of said steps (a)-(b).

7. The method for transforming information into intelligence assets in accordance with claim 1, wherein said providing an EIMS step (a) comprises multi-directional, hierarchal ranking of interpretations.

8. The method for transforming information into intelligence assets in accordance with claim 1, the steps further comprising:
g) providing means for receiving information from at least one source outside of an organization.

9. The method for transforming information into intelligence assets in accordance with claim 2, the steps further comprising:
h) providing consumer access to said intelligence trading platform.

10. The method for transforming information into intelligence assets in accordance with claim 2, the steps further comprising:
i) obtaining revenue from at least one of the sources: subscriptions, transaction fees, sales, report fees, consulting fees, agent fees, consumer fees, and value added services.

11. A method for transforming information into intelligence assets, the steps comprising:
a) providing an enterprise intelligence management system (EIMS) for collecting, interpreting, distributing and evaluating intelligence events and for creating intelligence assets therefrom; and
b) providing an intelligence trading platform operatively connected to said EIMS, for trading said intelligence assets.

12. The method for transforming information into intelligence assets in accordance with claim 11, wherein said EIMS comprises at least one of:
i) an enterprise employee module for gathering information, validating templates, allowing employee interpretation and recommendations, and providing supervisor threads for clarification;
ii) an intelligence client module for allowing brokers to gather, manage, and interpret said intelligence events;
iii) an adaptive template generator for defining the intelligence scheme and logic followed by said brokers;
iv) an adaptive context builder for analyzing threads and sources of said brokers;
v) an intelligence distribution module for distributing intelligence within an enterprise;
vi) an intelligence ranking module to evaluate and rate the interpretations of brokers, the intelligence reports, and the efficiency of the handling thereof; and
vii) a finance manager module to provide brokers with financial incentives, to disburse commissions, and to manage a virtual trust account for ensuring completion of a transaction between the consumer and the intelligence agent.

13. The method for transforming information into intelligence assets in accordance with claim 11, wherein said intelligence trading platform comprises at least one of:
i) a central intelligence management module (CIH);
ii) an adaptive context engine;
iii) a credibility manager;
iv) an adaptive template generator; and
v) an intelligence transactions manager for enabling a consumer to find information derived from an individual interpretation in response to a given intelligence request.

14. The method for transforming information into intelligence assets in accordance with claim 11, the steps further comprising:
c) generating an adaptive report in response to a request of a consumer.

15. The method for transforming information into intelligence assets in accordance with claim 11, wherein the Internet is used to perform at least one of said steps (a)-(b).

16. The method for transforming information into intelligence assets in accordance with claim 11, wherein said providing an EIMS step (a) comprises a multi-directional, hierarchal ranking of interpretations.

17. The method for transforming information into intelligence assets in accordance with claim 11, the steps further comprising:
d) receiving information from at least one source outside of an organization.

18. The method for transforming information into intelligence assets in accordance with claim 11, the steps further comprising:
e) providing consumer access to said intelligence trading platform.

19. The method for transforming intelligence events into intelligence assets in accordance with claim 11, further comprising:
f) obtaining revenue from at least one of the sources: subscriptions, transaction fees, sales, report fees, consulting fees, agent fees, consumer fees, and value added services.

20. The method for transforming information into intelligence events in accordance with claim 1, the steps further comprising:
j) the assigning a tangible value to at least one intelligence event.

21. The method for transforming intelligence events into intelligence assets in accordance with claim 2, the steps further comprising:
k) the assigning a tangible value to at least one intelligence event.

22. The method for transforming information into intelligence events in accordance with claim 20, the steps further comprising:
l) implementing a structured system to reward organization participants for contributing intelligence events;
m) customizing the structured reward system for any culture or location; and
n) basing said structured system on said value assigned to said at least one intelligence event.

23. The method for transforming intelligence data into intelligence events in accordance with claim 6, the steps further comprising:
l) providing multiple intelligence gathering web plug-ins to allow users to share intelligence data without connecting to said EIMS.

24. A method for transforming information into intelligence events, in accordance with claim 1, wherein said interpreting and evaluating steps (b) and (c) are determined by at least one of: culture, history, geography, education, politics, religion, experience and bias of an organization member.
